(19) United States
(12) Patent Application Publication
(10) Pub. No.: US 2023/0315283 A1
(43) Pub. Date: Oct. 5, 2023

(54) DISPLAY APPARATUS, DISPLAY METHOD, DISPLAY SYSTEM, AND RECORDING MEDIUM

(71) Applicant: Shigekazu TSUJI, Tokyo (JP)

(72) Inventor: Shigekazu TSUJI, Tokyo (JP)

(21) Appl. No.: 18/119,294

(22) Filed: Mar. 9, 2023

(30) Foreign Application Priority Data
Mar. 9, 2022 (JP) 2022-036536

(51) Int. Cl. G06F 3/04883; G06F 3/0482; G06V 30/22; G06V 30/32; G06F 3/04845

(52) U.S. Cl. CPC G06F 3/04883; G06F 3/0482; G06F 3/04845; G06V 30/22; G06V 30/32

(57) ABSTRACT

A display apparatus includes circuitry that displays, on a display, shape data; receives stroke data input to a user interface with an input device; determines whether the stroke data intersects with the shape data; based on a determination that the intersection is detected, converts the stroke data and the shape data, being collectively recognized, into converted shape data; and displays, on the display, the converted shape data in place of the shape data.

### CROSS-REFERENCE TO RELATED APPLICATIONS

This patent application is based on and claims priority pursuant to 35 U.S.C. §119(a) to Japanese Patent Application No. 2022-036536. filed on Mar. 9, 2022. in the Japan Patent Office, the entire disclosure of which is hereby incorporated by reference herein.

### BACKGROUND

### Technical Field

Embodiments of the present disclosure relate to a display apparatus, a display method, a display system, and a recording medium.

### Related Art

The background display apparatuses convert hand drafted data into character codes and display the character codes on a display by using the handwriting recognition technology. Such a display apparatus having a relatively large touch panel is used as, for example, an electronic whiteboard by a plurality of users in a conference room or a public facility.

### SUMMARY

Example embodiments include an apparatus, a method, and a program stored on a non-transitory recording medium, each of which: displays, on a display, shape data; receives stroke data input to a user interface with an input device; determines whether the stroke data intersects with the shape data; based on a determination that the intersection is detected, converts the stroke data and the shape data, being collectively recognized, into converted shape data; and displays, on the display, the converted shape data in place of the shape data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A, 1B, 1C, and 1D (FIGS. 1) are an illustration for explaining processing of generating two shapes, by a stroke handwritten on one shape, according to an exemplary embodiment;

FIGS. 2A, 2B, and 2C are diagrams each illustrating an example of a placement of a display apparatus in use, according to an exemplary embodiment:

FIG. 3 is a block diagram illustrating an example of a hardware configuration of the display apparatus according to an exemplary embodiment;

FIG. 4 is a block diagram illustrating an example of a functional configuration of the display apparatus according to an exemplary embodiment:

FIG. 5 is a table including information on object data, stored in an object data storage unit, according to an exemplary embodiment:

FIGS. 6A and 6B (FIGS. 6) illustrate processing to recognize input of a shape, as an example of a shape to be divided, according to an exemplary embodiment;

FIG. 7 is an illustration of examples of shapes on a list;

FIG. 8 is a diagram illustrating an example of a plurality of strokes determined to belong to the same recognition group according to an exemplary embodiment;

FIG. 9 is an illustration for explaining processing to determine an intersection point, according to an exemplary embodiment;

FIGS. 10A and 10B (FIGS. 10) are an illustration for explaining a case where the condition that the intersection angle is, for example, 80 to 100 degrees does not apply, according to an exemplary embodiment;

FIGS. 11A, 11B and 11C (FIGS. 11) are an illustration for explaining processing to divide a shape, according to an exemplary embodiment:

FIGS. 12A and 12B (FIGS. 12) are an illustration for explaining processing to convert a shape into a coordinate point sequence, according to an exemplary embodiment;

FIG. 13 is an illustration of the formatted divided shapes, respectively converted from the divided shapes, according to an exemplary embodiment;

FIG. 14 is a table that stores information on object data, stored in an object data storage unit, after the shape is divided, according to an exemplary embodiment;

FIG. 15 is a flowchart illustrating processing to input a shape, by the display apparatus, according to an exemplary embodiment:

FIGS. 16A and 16B (FIGS. 16) are an illustration for explaining processing to convert an original shape into two shapes, without being divided into two, according to an exemplary embodiment:

FIG. 17 is a flowchart illustrating processing to input a shape, by the display apparatus, according to an exemplary embodiment:

FIGS. 18A and 18B (FIGS. 18) are an illustration of an example of a shape to be divided in the horizontal direction, according to an exemplary embodiment;

FIGS. 19A and 19B (FIGS. 19) are an illustration of an example of a shape to be divided unequally, into a left part and a right part, according to an exemplary embodiment;

FIGS. 20A and 20B (FIGS. 20) are an illustration of an example of a shape to be divided into four shapes, according to an exemplary embodiment;

FIGS. 21A and 21B (FIGS. 21) are an illustration of an example of a shape to be divided into three shapes by a plurality of strokes that are parallel to each other, according to an exemplary embodiment;

FIGS. 22A, 22B, 22C, and 22D (FIGS. 22) are an illustration for explaining a case where a stroke is recognized as characters, according to an exemplary embodiment;

FIGS. 23A, 23B, 23C, and 23D (FIGS. 23) are an illustration of an example of dividing a triangular shape, according to an exemplary embodiment;

FIGS. 24A, 24B, and 24C (FIGS. 24) are an illustration for explaining processing a stroke input on a table, according to an exemplary embodiment;

FIGS. 25A, 25B, and 25C (FIGS. 25) are an illustration for explaining connection between shapes, according to an exemplary embodiment;

FIGS. 26A and 26B (FIGS. 26) are an illustration for explaining an example of connecting two rectangles and displayed side by side, according to an exemplary embodiment,

FIGS. 27A and 27B (FIGS. 27) are an illustration for explaining an example of connecting a rhombus and a rectangle displayed side by side, according to an exemplary embodiment;

FIGS. 28A and 28B (FIGS. 28) are an illustration for explaining an example of connecting two rhombuses displayed side by side, according to an exemplary embodiment;

FIG. 29 is a flowchart illustrating processing to connect shapes, performed by the display apparatus, according to an exemplary embodiment;

FIG. 30 is a list of example shapes used in the flowchart, according to an exemplary embodiment; and

FIG. 31 is a schematic diagram illustrating a configuration of a display system according to an exemplary embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a display apparatus and a display method performed by the display apparatus according to one or more embodiments, with reference to the attached drawings.

### First Embodiment

### Overview of Shape Input

The background display apparatus requires a user to switch between a mode for inputting a shape and a mode for inputting hand drafted data. For example, assuming that the display apparatus has a shape mode in which a shape is input (and formatted), and a handwritten character recognition mode in which a character (text) is input, it is necessary to switch from the handwritten character recognition mode to the shape mode in order for a user to input a shape while a character is being input. Similarly, in order for the user to input a character while a shape is being input, it is necessary to switch from the shape mode to the handwritten character recognition mode.

The display apparatus according to the present embodiment enables a user to create a new shape based on the previously-provided shape, without requiring the user to switch from the handwritten character recognition mode to the shape mode. The display apparatus performs, for example, the following processing. In this disclosure, the previously-provided shape, or the original shape, is a shape that is displayed at least when input of a stroke is received.

The display apparatus determines whether or not a stroke, which intersects the previously-provided shape perpendicularly, is input. The display apparatus determines a stroke intersecting the shape perpendicularly as a part of the shape, and a stroke not intersecting the shape perpendicularly as a character. Therefore, it is not necessary for the user to switch the mode from the handwritten character recognition mode to the shape mode.

When a stroke that intersects the previously-provided shape perpendicularly is input, the display apparatus converts the shape into a coordinate point sequence, and collectively recognizes the stroke (such as the vertical stroke) and the coordinate point sequence as a new shape. Since data of the stroke and the shape is converted into the coordinate point sequence, the display apparatus is able to recognize data of the shape and the stroke as a new shape in a similar manner as the previously-provided shape. Therefore, it is not necessary for the user to switch the mode from the handwritten character recognition mode to the shape mode.

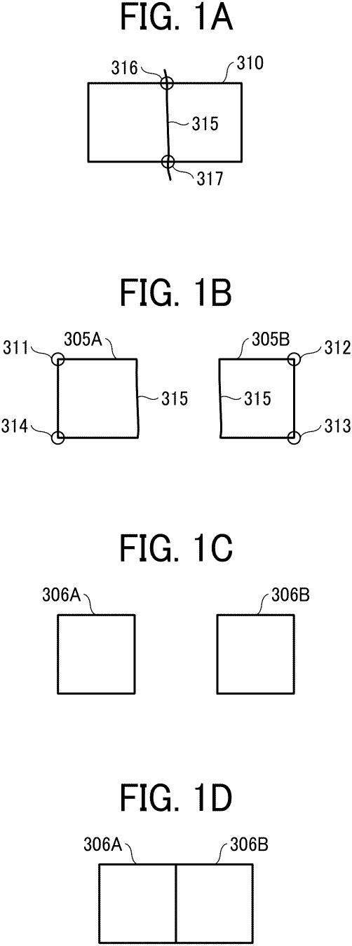

FIGS. 1A, 1B, 1C, and 1C (FIGS. 1) are an illustration for explaining processing of generating two shapes, by a stroke handwritten on one shape, according to an exemplary embodiment. In FIG. 1A, the user inputs (adds), by hand drafted input, a stroke 315 that intersects a formatted shape 310, which is a rectangle, perpendicularly. In this disclosure, the formatted shape 310 is a shape, which has been converted from hand drafted data to shape data; which has been determined using, for example, a list of shapes or a shape determination model as described below.

As illustrated in FIG. 1B, the display apparatus 2 divides the shape 310 at two intersection points 316 and 317. The display apparatus 2 then creates a divided shape 305A with a left half of the shape 310 with respect to the intersection points 316 and 317, and a part of the stroke 315 between the intersection points 316 and 317. Similarly, the display apparatus 2 creates a divided shape 305B with a right half of the shape 310 with respect to the intersection points 316 and 317, and a part of the stroke 315 between the intersection points 316 and 317.

As will be described later, the display apparatus 2 may convert the shape 310 and the stroke 315 collectively into two shapes, without dividing the shape 310 as illustrated in FIG. 1B.

Then, in each of the divided shapes 305A and 305B, the display apparatus 2 converts a left half of the shape 310 with respect to the intersection points 316 and 317, and a right half of the shape 310 with respect to the intersection points 316 and 317, each into a coordinate point sequence. Through this conversion, all strokes (that is, the left half of the shape 310 with respect to the intersection points 316 and 317, the part of the stroke 315 between the intersection points 316 and 317, the right half of the shape 310 with respect to the intersection points 316 and 317, and the part of the stroke 315 between the intersection points 316 and 317) will be recognized as hand drafted data.

As illustrated in FIG. 1C, the display apparatus 2 recognizes the divided shapes 305A and 305B, each converted into the coordinate point sequence, as new shapes. The display apparatus 2 can then convert the divided shapes 305A and 305B into two formatted divided shapes 306A and 306B.

The display apparatus 2 places the formatted divided shape 306A in a circumscribed rectangle of the divided shape 305A, and the formatted divided shape 306B in a circumscribed rectangle of the divided shape 305B, respectively, to display the formatted divided shapes 306A and 306B, as illustrated in FIG. 1D.

The display apparatus 2 newly recognizes and displays each shape, but in FIG. 1D, it looks as if the original shape 310 of FIG. 1A is divided into two regions from the user. In the following, the above-described processing may be simply referred to as division of a shape.

As described above, the display apparatus 2 according to the present embodiment enables a user to input a shape, without requiring the user to switch from the handwritten character recognition mode to the shape mode.

Since it is not necessary to switch the mode, the display apparatus 2 can perform character recognition without requiring the user to switch from the shape mode to the handwritten character recognition mode. For example, when the user inputs, by hand drafted data, a character inside a shape, the display apparatus 2 can convert the character into text. Further, since the display apparatus 2 recognizes the divided shape as a new shape, the previously-provided shape may be divided by one or more strokes to generate various types of shape. For example, there is no restriction that the shape can only be divided into upper, lower, left and right regions equally, or the shape can only be divided into two regions at a time.

In this disclosure, the input device may be any means with which a user inputs handwriting (hand drafting) by designating coordinates on a touch panel. Examples of the input device include, but are not limited to, a pen, a human finger, a human hand, and a bar-shaped member. Further, the touch panel is just one example of a user interface, which receives an user input with the input device.

A series of user operations including engaging a writing mode, recording movement of an input device or portion of a user, and then disengaging the writing mode is referred to as a stroke. The engaging of the writing mode may include, if desired, pressing an input device against a display or screen, and disengaging the writing mode may include releasing the input device from the display or screen. Alternatively, a stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The disengaging of the writing mode can be accomplished by the same or different gesture used to engage the writing mode, releasing the button, or otherwise turning off the writing mode, for example using the pointing device or mouse. A stroke includes tracking movement of the portion of the user without contacting a display or screen. In this case, the display apparatus may start tracking and recording (recognize engaging or turning on the writing mode) in response to a gesture of the user, pressing a button with a hand or a foot of the user, or other operation of, for example, using a mouse or pointing device. Further, the display apparatus may end tracking and recording (recognize disengaging or turning off the writing mode) in response to the same or different gesture, releasing the button, or other operation, for example using the mouse or pointing device.

Stroke data is data displayed on a display based on a trajectory of coordinates of a stroke input with the input device. The stroke data may be interpolated appropriately. Hand drafted data is data having one or more pieces of stroke data. Hand drafted input relates to a user input such as handwriting, drawing, and other forms of input. The hand drafted input may be performed via touch interface, with a tactile object such as a pen or stylus or with the user’s body. The hand drafted input may also be performed via other types of input, such as gesture-based input, hand motion tracking input or other touch-free input by a user. The following description may refer to hand drafted input and hand drafted input data, but other forms of hand drafted input may be utilized and are within the scope of the present disclosure.

Object refers to an item displayed on a screen and includes an object drawn by stroke data.

The term “object” in this disclosure also represents an object to be displayed.

An object obtained by handwriting recognition or hand drafted recognition and conversion of stroke data may include, in addition to character strings, a stamp of a given character or mark such as “complete,” a graphic such as a circle or a star, or a line.

A mode is a state of the display apparatus in which specific processing can be performed. An object selection mode is a mode in which selection of an object can be received.

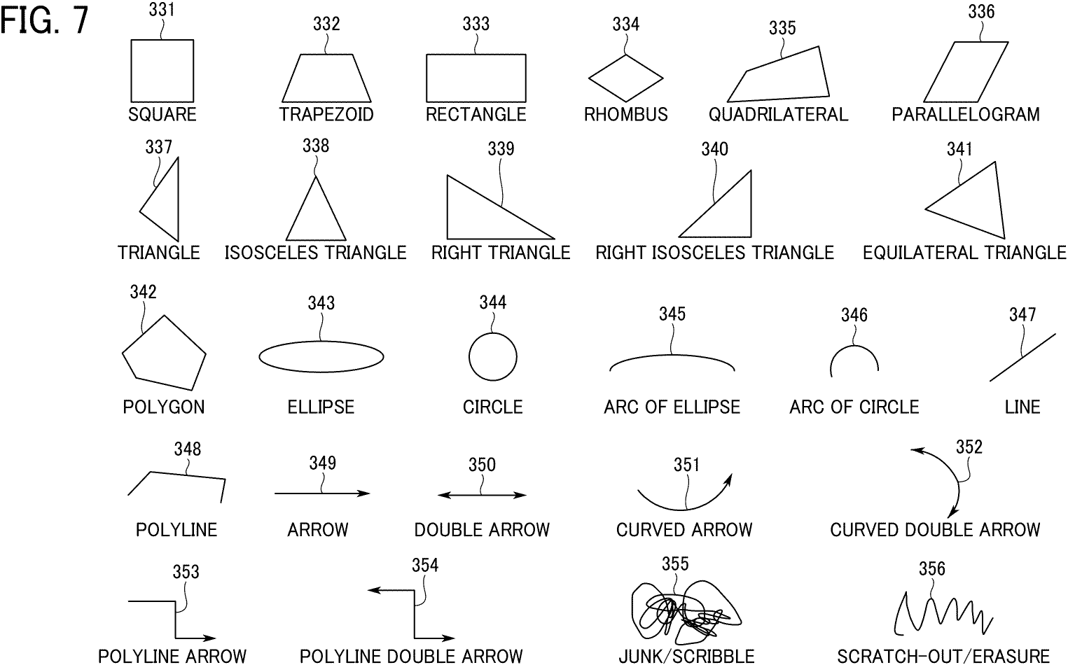

Examples of the shape include various shapes, outlines, contours, or line shapes, determined by a certain rule. Although there are many types of shapes such as triangle, quadrangle, circle, and rhombus, a shape that is recognizable is set in advance as illustrated in FIG. 7 below. Further, in this disclosure, the shape includes a table or any form of table.

### Configuration of Apparatus

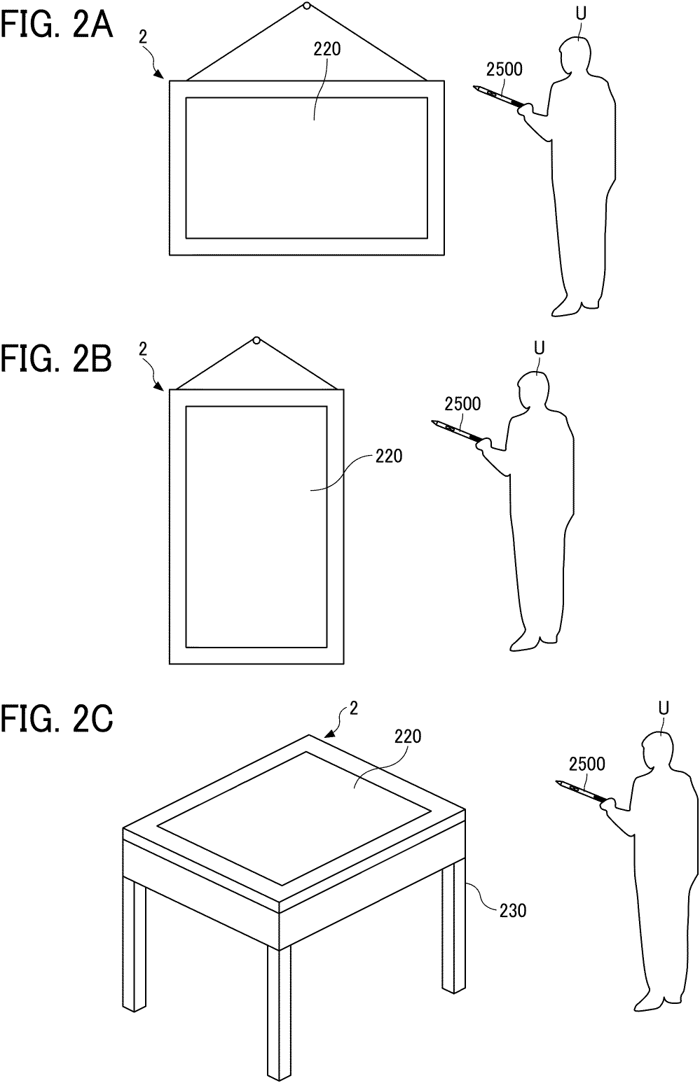

Referring to FIGS. 2A, 2B, and 2C, a description is given of a general arrangement of the display apparatus 2 according to the present embodiment. FIG. 2A to FIG. 2C are diagrams each illustrating an example of a placement of the display apparatus 2 in use according to the present embodiment. FIG. 2A illustrates, as an example of the display apparatus 2. an electronic whiteboard having a landscape-oriented rectangular shape and being hung on a wall.

As illustrated in FIG. 2A, the display apparatus 2 includes a display 220 (a screen). A user U handwrites (inputs or draws), for example, a character on the display 220 using a pen 2500.

FIG. 2B illustrates, as another example of the display apparatus 2, an electronic whiteboard having a portrait-oriented rectangular shape and being hung on a wall.

FIG. 2C illustrates, as another example, the display apparatus 2 placed on the top of a desk 230. The display apparatus 2 has a thickness of about 1 centimeter. It is not necessary to adjust the height of the desk 230, which is a general-purpose desk, when the display apparatus 2 is placed on the top of the desk 230. Further, the display apparatus 2 is portable and easily moved by the user.

Examples of an input method of coordinates by the pen 2500 include an electromagnetic induction method and an active electrostatic coupling method. In other example, the pen 2500 further has functions such as pen pressure detection, inclination detection, or a hover function (displaying a cursor before the pen is brought into contact).

### Hardware Configuration

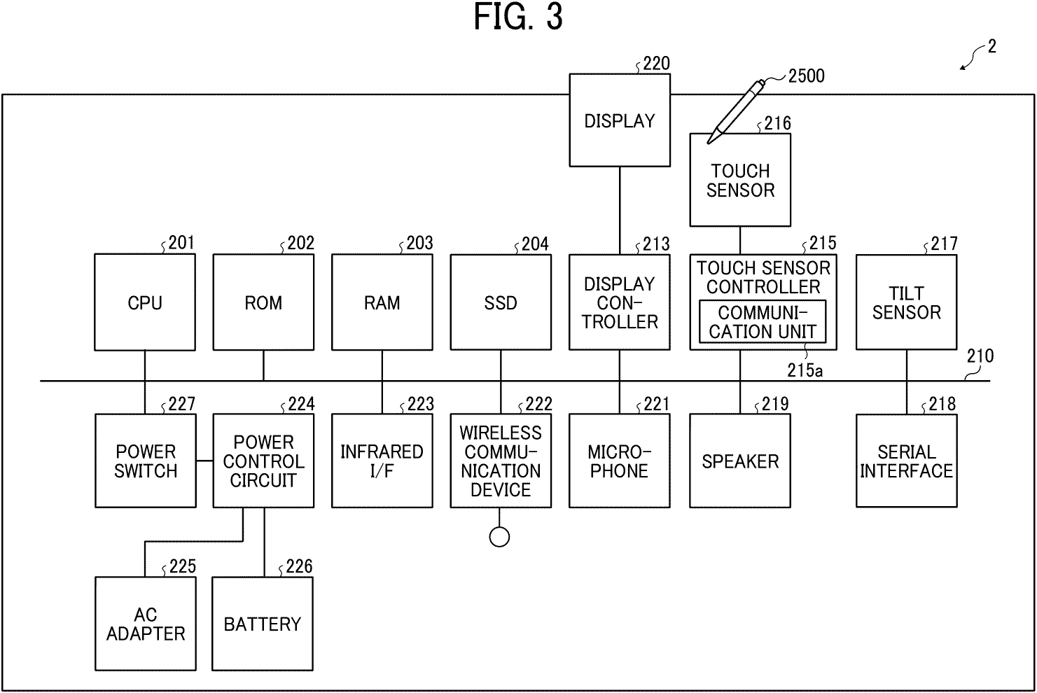

A description is given of a hardware configuration of the display apparatus 2 according to the present embodiment, with reference to FIG. 3. The display apparatus 2 has a configuration of an information processing apparatus or a computer as illustrated in FIG. 3. FIG. 3 is a block diagram illustrating an example of the hardware configuration of the display apparatus 2. As illustrated in FIG. 3, the display apparatus 2 includes a central processing unit (CPU) 201, a read only memory (ROM) 202, a random access memory (RAM) 203, and a solid state drive (SSD) 204.

The CPU 201 controls entire operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a control program for the display apparatus 2. The program may be an application program that runs on an information processing apparatus equipped with a general-purpose OS such as WINDOWS, MAC OS, ANDROID, and IOS. In this case, the display apparatus 2 is usually used as a general-purpose information processing apparatus. However, when a user executes an installed application program, the display apparatus 2 receives handwriting, or hand drafted input, performed by the user similarly to a dedicated display apparatus.

The display apparatus 2 further includes a display controller 213, a touch sensor controller 215, a touch sensor 216. a tilt sensor 217, a serial interface 218, a speaker 219, a display 220, a microphone 221, a wireless communication device 222, an infrared interface (I/F) 223, a power control circuit 224, an alternating current (AC) adapter 225, a battery 226, and a power switch 227.

The display controller 213 controls, for example, the display 220 to output an image thereon. The touch sensor 216 detects that the pen 2500, a user’s hand or the like is brought into contact with the display 220. The pen or the user’s hand is an example of input device. The touch sensor 216 also receives a pen identifier (ID).

The touch sensor controller 215 controls processing of the touch sensor 216. The touch sensor 216 receives touch input and detects coordinates of the touch input. A method of receiving a touch input and detecting the coordinates of the touch input will be described. For example, in a case of optical sensing, two light receiving and emitting devices, disposed on both upper side ends of the display 220, emit infrared ray (a plurality of lines of light) in parallel to a surface of the display 220. The infrared ray is reflected by a reflector provided around the display 220, and two light-receiving elements receive light returning along the same optical path as that of the emitted light. The touch sensor 216 outputs position information of the infrared ray that is blocked by an object after being emitted from the two light receiving and emitting devices, to the touch sensor controller 215. Based on the position information of the infrared ray, the touch sensor controller 215 detects a specific coordinate that is touched by the object. In addition, the touch sensor controller 215 includes a communication unit 215a that can communicate with the pen 2500 wirelessly. For example, when communication is performed in compliance with a standard such as BLUETOOTH, a commercially available pen can be used. When one or more pens 2500 are registered in the communication unit 215a in advance, the display apparatus 2 and the pen 2500 are communicably connected with each other without a user operation of setting for a connection between the pen 2500 and the display apparatus 2.

The power switch 227 turns on or off the power of the display apparatus 2. The tilt sensor 217 is a sensor that detects a tilt angle of the display apparatus 2. The tilt sensor 217 is mainly used to detect whether the display apparatus 2 is being used in any of the states in FIGS. 2A, 2B, or 2C. For example, the display apparatus 2 automatically changes the thickness of characters or the like depending on the detected state.

The serial interface 218 is a communication interface to connect the display apparatus 2 to extraneous sources such as a universal serial bus (USB). The serial interface 218 is used to input information from extraneous sources. The speaker 219 is used to output sound, and the microphone 221 is used to input sound. The wireless communication device 222 communicates with a communication terminal carried by the user and relays the connection to the Internet, for example.

The wireless communication device 222 performs communication in compliance with, for example, Wi-Fi or BLUETOOTH. Any suitable standard can be applied other than the Wi-Fi and BLUETOOTH. The wireless communication device 222 forms an access point. When a user sets a service set identifier (SSID) and a password that the user obtains in advance in the communication terminal carried by the user, the communication terminal is connected to the access point.

It is preferable that two access points are provided for the wireless communication device 222 as follows:

(a) Access point to the Internet; and (b) Access point to Intra-company network to the Internet. The access point (a) is for users other than, for example, corporate staffs. The access point (a) does not allow access from such users to the intra-company network but allow access to the Internet. The access point (b) is for corporate staffs as users, and such users can use the intra-company network and the Internet.

The infrared I/F 223 detects another display apparatus 2 adjacent thereto. For example, the infrared I/F 223 detects the adjacent display apparatus 2 using the straightness of infrared rays. Preferably, one infrared I/F 223 is provided on each side of the display apparatus 2. This configuration allows the display apparatus 2 to detect the direction in which the adjacent display apparatus 2 is disposed. Such an arrangement extends the space of display screen, and an object previously input by hand drafted input may be displayed on the adjacent display apparatus 2. In other words, because each display 220 may display an object corresponding to a single page, the display 220 of the adjacent display may display another page.

The power control circuit 224 controls the AC adapter 225 and the battery 226, which are power supplies for the display apparatus 2. The AC adapter 225 converts alternating current shared by a commercial power supply into direct current.

In a case where the display 220 is a so-called electronic paper, the display 220 consumes little or no power to maintain image display. In such case, the display apparatus 2 may be driven by the battery 226. This allows the display apparatus 2 to be used as, for example, a digital signage that is also usable in a place, such as outdoors, where a power source is hardly secured.

The display apparatus 2 further includes a bus line 210. The bus line 210 is, for example, an address bus or a data bus that electrically connects the elements illustrated in FIG. 3, such as the CPU 201.

The touch sensor 216 is not limited to an optical touch sensor, but may use, for example, a capacitive touch panel that locates a contact position by detecting a change in capacitance. Further, the touch sensor 216 may use a resistance film touch panel that identifies a contact position by a change in voltage of two opposing resistance films. In another example, the touch sensor 216 may use an electromagnetic induction touch panel that identifies a contact position by detecting electromagnetic induction caused by contact of an object to the display, or may use various sensing devices. The touch sensor 216 can be of a type that does not require an electronic pen to detect whether the pen tip is in contact with the surface of the display 220. In this case, a fingertip or a pen-shaped stick is used for touch operation. In addition, the pen 2500 may have any suitable shape other than a slim pen shape.

### Functions

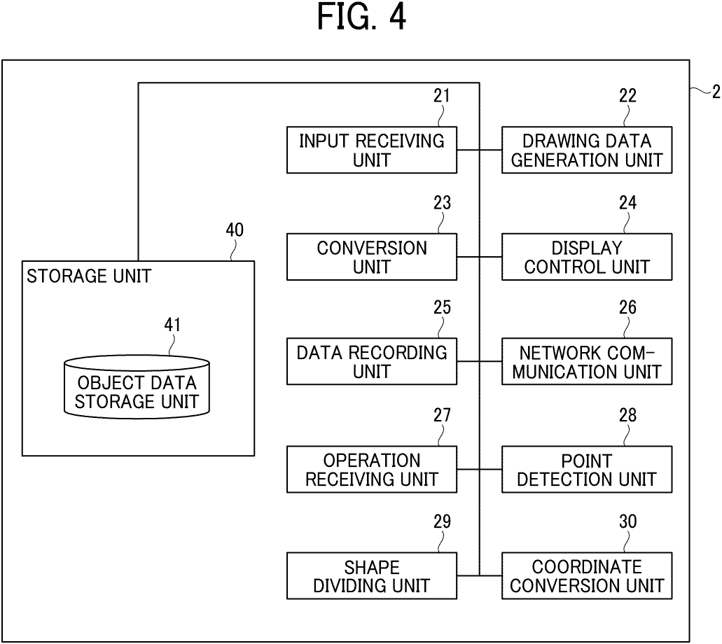

A functional configuration of the display apparatus 2 according to the present embodiment is described below with reference to FIG. 4. FIG. 4 is a block diagram illustrating an example of the functional configuration of the display apparatus 2 according to the present embodiment. The display apparatus 2 includes an input receiving unit 21, a drawing data generation unit 22, a conversion unit 23. a display control unit 24, a data recording unit 25, a network communication unit 26, an operation receiving unit 27, an point detection unit 28, a shape dividing unit 29, and an coordinate conversion unit 30. The functional units of the display apparatus 2 are implemented by or are caused to function by operation of one or more of the elements illustrated in FIG. 3 according to an instruction from the CPU 201 according to a program loaded from the SSD 204 to the RAM 203.

The input receiving unit 21 receives input of stroke data (coordinate point sequence) by detecting coordinates of a position at which an input device such as the pen 2500 contacts the touch sensor 216. The drawing data generation unit 22 acquires coordinates of each position touched by the pen tip of the pen 2500 from the input reception unit 21.

The drawing data generation unit 22 connects a plurality of contact coordinates into a coordinate point sequence by interpolation, to generate stroke data.

The conversion unit 23 performs character recognition processing on one or more stroke data (hand drafted data) of same recognition group, hand-drafted by the user and converts the stroke data into text (one or more character codes) as an example of converted object. The conversion unit 23 recognizes characters (of multilingual languages such as English as well as Japanese), numbers, symbols (e.g., %, $, and &), shapes (e.g.. lines, circles, triangles, and rectangles). Specifically, for input of each stroke, the conversion unit 23 repeatedly performs recognition processing concurrently with a pen operation by the user. Although various algorithms have been proposed for the recognition method, a detailed description is omitted on the assumption that known techniques can be used in the present embodiment.

The display control unit 24 displays, on the display 220, hand drafted data, a text converted from the hand drafted data, and an operation menu to be operated by the user. The data recording unit 25 stores hand drafted data input on the display apparatus 2, converted text, a screenshot on a personal computer (PC) screen, a file, and the like in a storage unit 40 (a memory). The network communication unit 26 connects the display apparatus 2 to a network such as a local area network (LAN), and transmits and receives data to and from other devices via the network.

Based on the coordinates of the position in contact with the pen 2500, the operation receiving unit 27 receives selection of a particular text from a plurality of conversion candidates generated by character recognition or receives pressing of a menu.

The point detection unit 28 determines whether or not the stroke intersects a side of the converted (formatted) shape perpendicularly. When the stroke intersects the side of the shape perpendicularly, the point detection unit 28 also specifies the intersection point.

The shape dividing unit 29 divides the previously-provided shape into a right region and a left region based on the intersection points of the shape, or into an upper region and a lower region based on the intersection points of the shape. The number of divisions into which the previously-provided shape is divided depends on the number of strokes being input.

The coordinate conversion unit 30 converts the shapes of the right region and the left region with respect to the intersection, or the shapes of the upper region and the left region with respect to the intersection, respectively, into coordinate point sequences.

The display apparatus 2 includes a storage unit 40 implemented by, for example, the SSD 204 or the RAM 203 illustrated in FIG. 3. The storage unit 40 includes an object data storage unit 41.

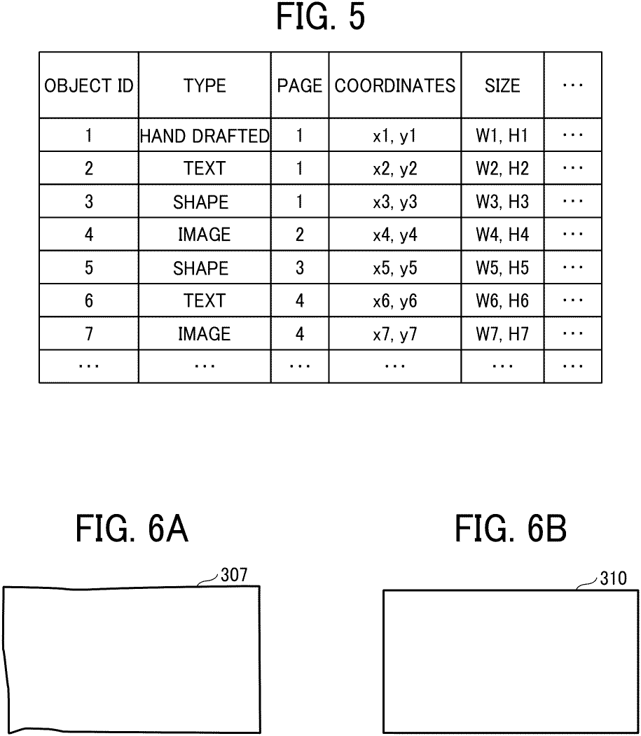

FIG. 5 is a table that stores information on object data, stored in the object data storage unit 41.

The item “object ID” is identification information for identifying display data.

The item “type” is a type of object data and includes hand drafted, text, shape, image, and table, for example. “Hand drafted” indicates stroke data (coordinate point sequence). “Text” indicates a character string (one or more character codes) converted from hand drafted data. “Shape” indicates a geometric shape, such as a triangle and a quadrangle, each of which is converted from hand drafted input data. “Image” indicates image data in a format such as Joint Photographic Experts Group (JPEG). Portable Network Graphics (PNG), or Tagged Image File Format (TIFF) acquired from, for example, a PC or the Internet. “Table” indicates a one-dimensional or two-dimensional object that is a table.

A screen of the display apparatus 2 may include a page. A page item is indicated by page number.

An item of coordinates indicates a position of object data with reference to a predetermined origin on a screen of the display apparatus 2. The position of the object data is, for example, the position of the upper left apex of a circumscribed rectangle of the object data. The coordinates are expressed, for example, in pixels of the display.

The item “size” indicates a width and a height of the circumscribed rectangle of the object data.

### Detection of Intersection Point

Referring now to FIGS. 6 to 9, processing to detect an intersection point is described according to the embodiment. FIGS. 6A and 6B illustrate processing to recognize input of a shape 310, as an example of a shape to be divided. FIG. 6A is an example of a rectangle 307. which is hand drafted. The rectangle 307 is recognized as a coordinate point sequence, after it is input as hand drafted data. Since data used for conversion is a sequence of coordinate points, the hand drafted data of FIG. 6A may be written with a single stroke or a plurality of strokes. In this disclosure, among the plurality of strokes being input, strokes that are collectively recognized are referred to as strokes belonging to the same recognition group. Processing to determine strokes in the same recognition group is described in detail later.

The conversion unit 23 compares the strokes in the same recognition group with shapes in a shape list, and converts the strokes in the same recognition group into a shape 310 having a form close to the form of the strokes in the same recognition group. FIG. 6B is an example of a converted (formatted) shape 310. The shape 310 in FIG. 6B is a rectangle. The lengths of the long side and the short side of the rectangle may be determined from, for example, a circumscribed rectangle of the rectangle 307 that is hand drafted.

FIG. 7 illustrates examples of shapes on the list.

The first row of FIG. 7 is for shapes of quadrangle including a square 331, a trapezoid 332, a rectangle 333, a rhombus 334, a quadrilateral 335, and a parallelogram 336.

The second row is for shapes of triangle including a triangle 337, an isosceles triangle 338, a right triangle 339, a right-angled isosceles triangle 340. and an equilateral triangle 341.

The third row is for shapes including a polygon such as a pentagon 342, an ellipse 343, a circle 344, an arc of ellipse 345, an arc of circle 346, and a line 347.

The fourth row is for shapes including a polyline 348, a single headed arrow (arrow) 349, a double arrow 350, a curved arrow 351, and a curved double arrow 352.

The fifth row is for shapes including a polyline single arrow 353, a polyline double arrow 354. a junk/scribble 355. and a scratch (scratch-out/erasure) 356.

As one method of comparing, with a shape, an outline or a line shape of a plurality of strokes (one or more strokes) determined to belong to the same recognition group, for example, there is a method of performing pattern matching between the outline or the line shape of the plurality of strokes (one or more strokes) and each shape in the shape list. As another example, there is a method using machine learning. For example, any desired information processing apparatus previously learns correspondence between an image of one or more strokes for each shape and the corresponding shape in the shape list by machine learning such as a neural network to create a shape determination model. The shape determination model outputs a probability corresponding to each shape for the image of the one or more strokes. The conversion unit 23 inputs a plurality of strokes (one or more strokes) determined to belong to the same recognition group to the shape determination model, and converts them into a shape determined to have the highest degree of similarity.

The machine learning is a technique for causing a computer to acquire human-like learning capability, and refers to a technique in which a computer autonomously generates an algorithm necessary for determination of data identification or the like from learning data acquired in advance, and applies the algorithm to new data to perform prediction. Any suitable learning method is applied for machine learning, for example, any one of supervised leaming, unsupervised learning, semi-supervised leaming, reinforcement learning, and deep learning, or a combination of two or more those learning. Machine learning methods include, but not limited to, perceptron, support vector machine, logistic regression, naïve Bayes, decision tree, and random forest.

Strokes belonging to the same recognition group

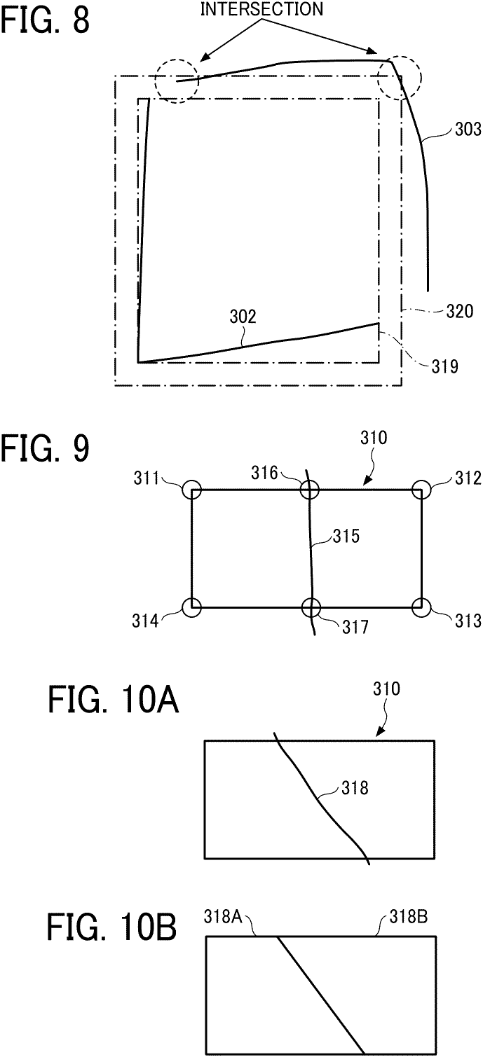

FIG. 8 is a diagram illustrating an example of a plurality of strokes determined to belong to the same recognition group according to the exemplary embodiment. Whether or not a plurality of strokes belong to the same recognition group is that “another stroke handwritten within a certain period of time intersects a rectangle in the vicinity of a stroke”. In FIG. 8, a stroke 302 is hand drafted. The conversion unit 23 sets a neighborhood rectangle 320, which surrounds a circumscribed rectangle 319 of the stroke 302. The neighborhood rectangle 320 is, for example, a rectangle obtained by adding an offset to each of the upper, lower, left, and right sides of the circumscribed rectangle of the stroke 302.

Further, in this example, before a certain period of time elapses since the user releases input of the stroke 302, the user inputs, by hand drafted data, a stroke 303. The stroke 303 intersects the neighborhood rectangle 320. Accordingly, the conversion unit 23 determines that the stroke 302 and the stroke 303 belong to the same recognition group.

The method of determining the strokes belonging to the same recognition group described referring to FIG. 8 is one example. Alternatively, the strokes belonging to the same recognition group may be determined without using the neighborhood rectangle. For example, the strokes belonging to the same recognition group to form a shape may be determined based on whether a condition that the height or width of the strokes is greater than a certain value.

Presence or Absence of Intersection Point and Determination of Intersection Point

FIG. 9 is an illustration for explaining processing to determine an intersection point, according to the embodiment. In FIG. 9, a stroke 315 is hand drafted, perpendicularly, on the formatted rectangle (shape) 310. The point detection unit 28 performs, for example, the following processing to determine whether conditions (i) to (iii) are satisfied.

(i) The point detection unit 28 detects the stroke 315 representing a straight line. For example, the point detection unit 28 calculates an equation of a straight line based on the stroke 315, by applying the least square method or the Hough transform to the stroke 315.

(ii) The point detection unit 28 determines whether the obtained straight line intersects with two opposing sides of the shape 310. For example, the point detection unit 28 converts each side of the shape 310 into a straight line, and detects an intersection point between the straight line obtained from each side and the straight line obtained from the stroke 315.

(iii) When the straight line of the stroke 315 intersects with the two opposing sides of the shape, the point detection unit 28 determines whether or not an intersection angle is, for example, 80 to 100 degrees. The intersection angle between the two intersecting straight lines may be determined using any desired known method, such that its range may be changed as appropriate as long as it can indicate that the straight line intersects perpendicularly.

When the above-described conditions (i) to (iii) are satisfied, the point detection unit 28 determines that the stroke 315 intersects the opposing sides of the converted (formatted) shape 310 perpendicularly. In this case, the intersection point (in this case, two intersection points) is also obtained at (ii).

When the conditions (i) to (iii) are satisfied as described above, it is also determined that the stroke 315 divides the shape 310. Accordingly, the stroke 315 alone is not converted into a straight line.

The condition indicating whether or not the intersection angle is, for example, 80 to 100 degrees is equivalent to making a determination of whether or not the stroke intersects the sides of the shape perpendicularly. However, this condition is suitable for dividing a rectangular shape into smaller rectangles, and may not necessarily depend on a shape to be divided.

FIGS. 10A and 10B are an illustration for explaining a case where the condition that the intersection angle is, for example, 80 to 100 degrees is not considered. In FIG. 10A, an oblique stroke 318 is hand drafted on the shape 310. Since the conversion unit 23 newly recognizes the divided shape formed by the shape 310 and the stroke 318, the shape is divided into two trapezoids 318A and 318B as illustrated in FIG. 10B. As described above, the user may want to diagonally divide the shape 310, and if this is the case, the condition of whether the intersection angle is, for example, 80 to 100 degrees does not have to be considered. Such setting regarding the intersection angle may be previously set.

### Division of Shape

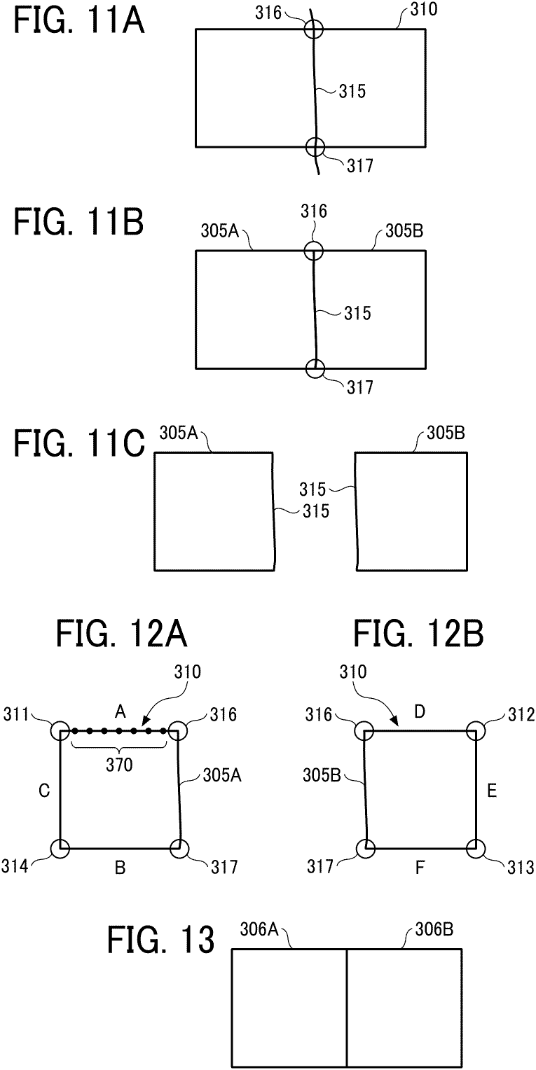

Next, with reference to FIGS. 11A, 11B, and 11C, processing to divide a shape using an intersection point is described according to the embodiment. FIGS. 11A to 11C are an illustration for explaining processing to divide a shape. FIG. 11A illustrates the shape 310 in which the intersection points are detected in FIG. 9. The shape dividing unit 29 may first delete a part of the stroke 315 outside the shape 310 (FIG. 11B). This processing is not necessarily required, and the entire stroke 315 may be left.

Further, in this disclosure, the stroke does not have to input such that the stroke crosses the sides of the shape. For example, the stroke may be input, such that the stroke has a contact point with the sides of the shape. In such case, deletion of a part of the stroke 315 outside the shape 310 is not necessary. For simplicity, however, intersection is assumed to include the case where the stroke is in contact with the side of the shape. In other words, as long as the stroke shares a common point with the shape, it is assumed that the stroke intersects the shape.

Then, the shape dividing unit 29 creates a divided shape 305A and a divided shape 305B, as illustrated in FIG. 11C. The divided shape 305A is formed by a left half of the shape 310 with respect to the intersection points 316 and 317 and the stroke 315 between the intersection points. The divided shape 305B is formed by a right half of the shape 310 with respect to the intersection points 316 and 317 and the stroke 315 between the intersection points.

More specifically, the shape dividing unit 29 traces black pixels clockwise from an arbitrary vertex 311 of the shape (FIGS. 12A and 12B). If there is a branch such as the intersection point 316 or 317. the shape dividing unit 29 continues to trace black pixels clockwise to determine whether or not the vertex 311, as an origin or starting point, has been reached. In such case, the shape dividing unit 29 does not pass through a part of the shape 310 which has passed through once, and traces the black pixels clockwise from the intersection point 316 or 317 where there is a branch. In this way, the divided shapes 305A and 305B, each being formed by black pixels, are obtained.

Therefore, the stroke 315 is used for dividing the shape 305, that is, for creating each of the divided shapes 305A and 305B. For the purpose of description, the divided shapes 305A and 305B of FIG. 11C are illustrated separately, but the coordinates of the divided shapes 305A and 305B are the same as those of the shape 310.

### Conversion to a Coordinate Point Sequence

Referring next to FIGS. 12A and 12B, conversion of a part of the divided shape 305A belonging to the shape 310 and a part of the divided shape 305B belonging to the shape 310, each into a coordinate point sequence is described according to the embodiment. FIGS. 12A and 12B are an illustration for explaining processing to convert a shape into a coordinate point sequence, according to the embodiment. The coordinate conversion unit 30 converts sides of each of the divided shapes 305A and 305B, corresponding to a part of the shape 310, into a coordinate point sequence. It is assumed that such sides, subjected to conversion, have already been converted into a linear expression. FIG. 12A illustrates the vertex 311, the intersection points 316 and 317, and a vertex 314 of the divided shape 305A. FIG. 12B illustrates the intersection point 316, a vertex 312, a vertex 313, and the intersection point 317 of the divided shape 305B. The coordinate conversion unit 30 calculates a coordinate point sequence from the straight line of each side, as follows:
Side A between vertex 311 and intersection point 316;
Side B between intersection point 317 and vertex 314;
Side C between vertex 314 and vertex 311;
Side D between intersection point 316 and vertex 312:
Edge E between vertex 312 and vertex 313; and
Side F between vertex 313 and intersection point 317.

Specifically, the coordinate conversion unit 30 changes the x coordinate or the y coordinate in the equation of the straight line of each side, by a small amount Δx or Δy, to calculate the y coordinate or the x coordinate of the point on the straight line. The coordinate conversion unit 30 determines to change whether the x coordinate or the y coordinate according to a preset rule. For example, the coordinate conversion unit 30 changes the x coordinate for the horizontal straight line and changes the y coordinate for the vertical straight line. The coordinate conversion unit 30 determines whether the straight line is horizontal or vertical based on a slope of the straight line.

In this way, a coordinate point sequence 370 is obtained for each of the sides A to F. The small amount Δx or Δy is set so as to obtain the number of coordinate point sequences 370 required for recognition of a shape.

The conversion unit 23 compares each of the divided shapes 305A and 305B with shapes in the shape list, and converts each of the divided shapes 305A and 305B into a shape having the highest similarity.

### Example of Converted Shape After Division

FIG. 13 illustrates the formatted divided shapes 306A and 306B, respectively converted from the divided shapes 305A and 305B. The formatted divided shape 306A is a shape obtained by converting the divided shape 305A. The formatted divided shape 306B is a shape obtained by converting the divided shape 305B. The conversion unit 23 places the formatted divided shape 306A in a circumscribed rectangle of the divided shape 305A, and the formatted divided shape 306B in a circumscribed rectangle of the divided shape 305B, respectively, to display the formatted divided shapes 306A and 306B. Therefore, the positions and heights of the formatted divided shape 306A and 306B are determined by the shape 310, and the widths of the formatted divided shapes 306A and 306B are determined by the position of the stroke 315. Although the formatted divided shapes 306A and 306B seem to together form one shape, they are actually two independent shapes that are adjacent to each other.

The formatted divided shapes 306A and 306B inherit the attributes of the original shape 310. In this disclosure, the attributes include, for example, a form of a shape and a character in the shape, as follows. With this configuration, when the use handwrites characters in the formatted divided shape 306A or 306B, it is not necessary for the user to reset a font, for example.

The attributes include: line thickness, line color, and line type of a shape; font of a character in the shape; font size of the character in the shape: font color of the character in the shape; and alignment of character in the shape (alignment of character can be specified in terms of the horizontal direction (leftward, center, or rightward) or the vertical direction (top, center, or bottom)).

FIG. 14 is a table that stores information on object data, stored in the object data storage unit 41, after the shape is divided. In the following description of FIG. 14, differences from FIG. 5 are mainly described. In FIG. 14, the shape identified with the object ID of 5 is divided. Therefore, an object ID is newly assigned for each divided shape. For example, the shape with the object ID of 5 - 1 is the formatted divided shape 306A. and the shape with the object ID of 5 - 2 is the formatted divided shape 306B. As the coordinates and size, the values of the formatted divided shape 306A and 306B are set.

### Processing

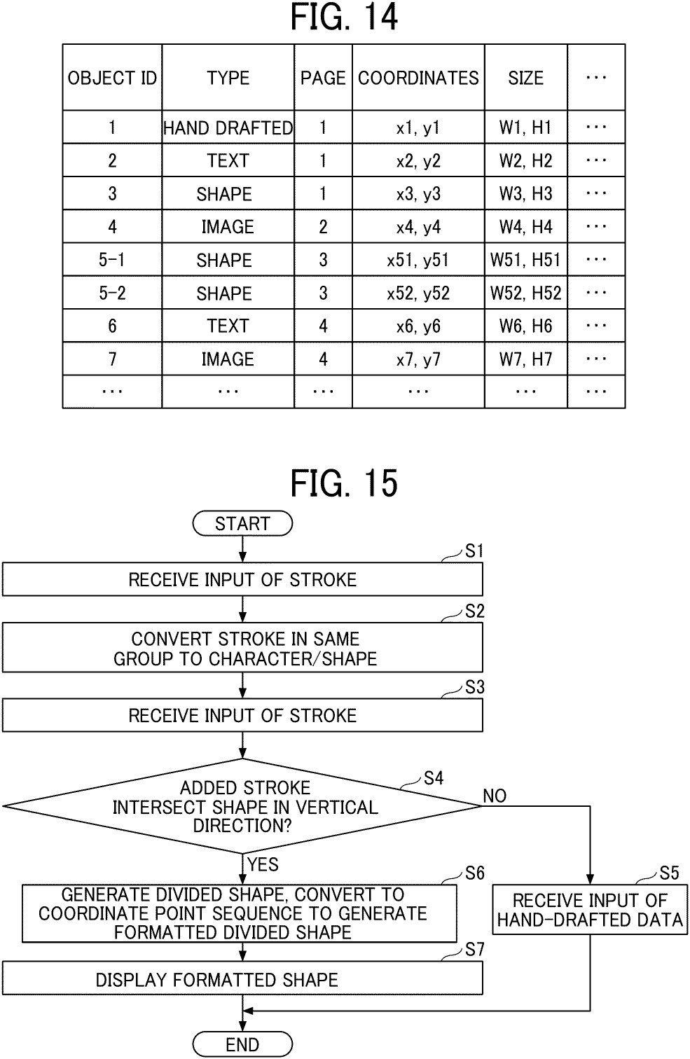

FIG. 15 is a flowchart illustrating processing to input a shape, by the display apparatus 2, according to the embodiment. The processing of FIG. 15 starts when the display apparatus 2 is powered on.

A user handwrites one or more strokes, which together form a rectangle. The input receiving unit 21 receives input of stroke data (coordinate point sequence) by detecting coordinates of a position at which an input device such as the pen 2500 contacts the touch sensor 216. The drawing data generation unit 22 acquires coordinates of each position touched by the pen tip of the pen 2500 from the input reception unit 21. The drawing data generation unit 22 connects a plurality of contact coordinates into a coordinate point sequence by interpolation, to generate stroke data (S1).

When it is determined that one or more strokes belonging to the same recognition group are input, the conversion unit 23 converts the one or more strokes of the same recognition group into a character or a shape (S2). In this example, it is assumed that the one or more strokes belonging to the same recognition group are converted into a shape.

Next, the user handwrites a stroke, which divides the shape being input. While the user may handwrites more than one stroke, the following uses the term “stroke” to indicate one or more strokes for simplicity. The input receiving unit 21 receives input of stroke data (coordinate point sequence) by detecting coordinates of a position at which an input device such as the pen 2500 contacts the touch sensor 216. The drawing data generation unit 22 acquires coordinates of each position touched by the pen tip of the pen 2500 from the input reception unit 21. The drawing data generation unit 22 connects a plurality of contact coordinates into a coordinate point sequence by interpolation, to generate stroke data (S3).

The point detection unit 28 determines whether or not the stroke data generated at step S3 intersects the shape obtained at S2 in perpendicularly (S4). In this example, S4 is determined to be YES when there are two points of intersection. However, the user may previously set such that S4 is determined to be YES, even when there is only one point of intersection.

When the determination at S4 is NO, the stroke input at S3 is determined simply as hand drafted data (S5). In such case, the conversion unit 23 may perform character recognition on the stroke data obtained at S3.

When the determination at step S4 is YES, the shape dividing unit 29 divides the shape obtained at S2 by the stroke input at S3, into a plurality of shapes. The coordinate conversion unit 30 converts the divided shapes each into a coordinate point sequence.

The conversion unit 23 then converts each of the divided shapes into a formatted divided shape (S5). In this example, it is assumed that two divided shapes are converted into two formatted divided shapes.

The display control unit 24 deletes the shape obtained at S2 and displays the two formatted divided shapes (S7).

As described above, the display apparatus 2 recognizes a stroke that intersects a shape in the horizontal direction, as a part of the shape. Therefore, it is not necessary for the user to switch the mode from the handwritten character recognition mode to the shape mode. Further, the display apparatus 2 converts the divided shape into a coordinate point sequence, and recognizes the coordinate point sequence together with the stroke. Accordingly, the display apparatus 2 can recognize the divided shape in a substantially similar manner with the original shape, without requiring the user to switch from the handwritten character recognition mode to the shape mode.

### Variations

### Processing to Generate Two Shapes Without Dividing an Original Shape Into Two Shapes

Referring to FIGS. 9 to 13, the original shape 310 is divided into two shapes by the stroke 315, and then each converted into the coordinate point sequence. Without requiring the original shape 310 to be divided into two shapes, the coordinate conversion unit 30 is able to convert the shape into a coordinate point sequence, such that the conversion unit 23 divides the shape into two shapes.

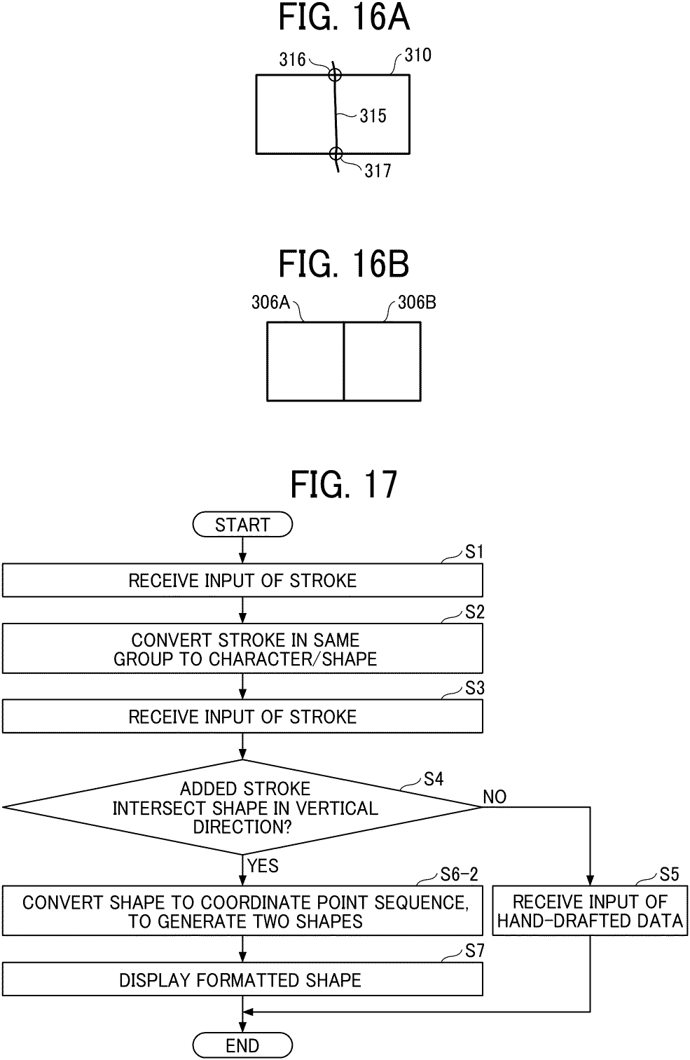

FIGS. 16A and 16B are an illustration for explaining processing to convert the original shape 310 into two shapes, without being divided into two. As illustrated in FIG. 16A, the user additionally handwrites a stroke 315 that intersects opposite sides of the formatted shape 310 perpendicularly. The coordinate conversion unit 30 converts all lines of the shape 310 into a coordinate point sequence. The conversion unit 23 newly recognizes the coordinate point sequence of the shape 310 and the stroke 315, as two separate shapes 306A and 306B as illustrated in FIG. 16B. Specifically, the conversion unit 23 adds the stroke 315 to the shape 310, and performs recognition processing on the shape 310 and the stroke 315 to obtain new shapes.

FIG. 17 is a flowchart illustrating processing to input a shape, by the display apparatus 2. according to another embodiment. In the description referring to FIG. 17, for simplicity, mainly differences from FIG. 15 are described.

In FIG. 17, at S6-2, the coordinate conversion unit 30 converts the shape 310 into a coordinate point sequence. The conversion unit 23 then converts the shape 310 and the stroke 315 into a new shape. In this example, the shape 310 and the stroke 315 are converted into two shapes, which correspond to the formatted divided shapes.

### Other Examples of Inputting Shape

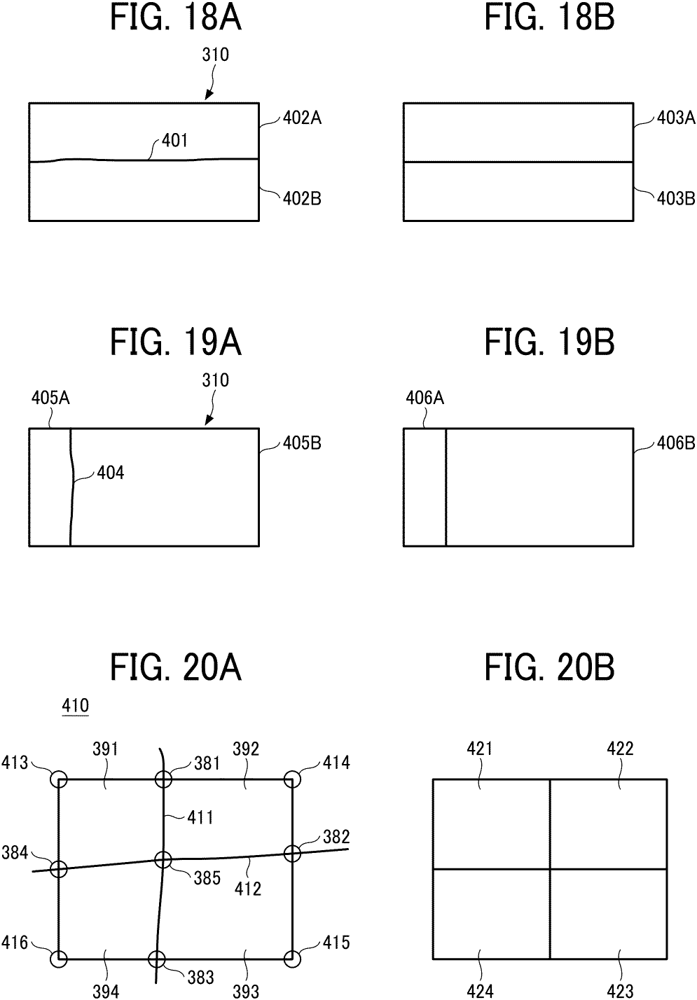

Referring now to FIGS. 18 to 24, other examples of inputting a shape, by adding a stroke to a previously-provided shape, are described according to embodiments. FIGS. 18A and 18B illustrate an example of a shape to be divided in the horizontal direction. In FIG. 18A, a horizontal stroke 401 is handwritten on a shape 310. As illustrated in FIG. 18B, also in this case, the stroke 401 perpendicularly intersects sides of the shape 310. Accordingly, the conversion unit 23 converts divided shapes 402A and 402B, divided by the stroke 401, into formatted converted shapes 403A and 403B. It seems to the user that the shape 310 is divided into an upper part and a lower part.

The display apparatus 2 according to the present embodiment does not necessarily divide a shape evenly, such that the display apparatus 2 may divide a shape unevenly according to a position of the handwritten stroke. FIGS. 19A and 19B illustrate an example of a shape 310, to be divided unequally, into a left part and a right part. In FIG. 19A, a stroke 404 perpendicular to the shape 310 is handwritten, but the position of the stroke 404 is toward the left. The display apparatus 2 according to the present embodiment recognizes divided shapes 405A and 405B to convert them into formatted divided shapes 406A and 406B, respectively. The widths of the formatted divided shapes 406A and 406B are determined according to the position of the stroke 404.

For example, when the user uses the divided shape 310 as a table, it is possible to input a number to the formatted divided shape 406A that is narrow, and a character string (text) to the formatted divided shape 406B that is wide.

When the user wants to divide the shape equally, for example, hand drafted data, such as “equal”, may be input to execute a command. For example, immediately after the shape is divided as illustrated in FIG. 19B, the user may write “equal” by hand. The conversion unit 23 recognizes the term “equal” and displays a command associated with the term “equal”. When the user selects a command with the pen 2500, the conversion unit 23 adjusts the widths of the formatted divided shapes 406A and 406B, converted immediately before, to be equal to each other.

Further, as illustrated in FIGS. 20A and 20B, the display apparatus 2 according to the present embodiment may divide one shape not only into two but also into four or more. FIGS. 20A and 20B illustrate an example of a shape to be divided in four shapes. In FIG. 20A, a vertical stroke 411 and a horizontal stroke 412 are handwritten on a shape 410. In such case, since each of the two strokes 411 and 412 is converted into a linear expression, the point detection unit 28 detects not only the intersection points 381 to 384 between the two strokes 411 and 412 and the shape 410, but also the intersection point 385 between the two strokes 411 and 412.

More specifically, the shape dividing unit 29 traces black pixels clockwise from an arbitrary vertex 413. If there is a branch such as the intersection point 381 or 385, the shape dividing unit 29 continues to trace black pixels clockwise to determine whether or not the vertex 413, as the original or starting point, has been reached. First, a divided shape 391 is found. The shape dividing unit 29 does not pass through a part of the shape 410 which has passed through once, and traces the black pixels clockwise from the intersection point 381 (or 385 or 384) where there is a branch. Next, a divided shape 392 is found. The shape dividing unit 29 traces the black pixels clockwise from the intersection point 382 (or 385 or 384) where there is a branch, in a similar manner. Next, a divided shape 393 is found. The shape dividing unit 29 traces the black pixels clockwise from the intersection point 383 (or 385) where there is a branch, in a similar manner. Next, a divided shape 394 is found.

In this way, the shape dividing unit 29 can divide the shape 410 into four divided shapes 391 to 394. For example, the divided shape 391 is formed by a straight line between the vertex 413 and the intersection point 384, a straight line between the vertex 413 and the intersection point 381, a stroke 411 between the intersection point 381 and the intersection point 385, and a stroke 412 between the intersection point 385 and the intersection point 384. The same applies to the other divided shapes 392 to 394.

As illustrated in FIG. 20B, the conversion unit 23 then converts the divided shapes 391 to 394 into four formatted divided shape 421 to 424, respectively.

Whether the stroke is divided by one stroke or divided by a plurality of strokes is determined by comparing a period of time from the time when input of one stroke ends to the time when input of a next stroke starts, with a threshold value. The start or end of input is determined whether the pen, or finger, is made in contact with (start) or apart from (end) a display screen. When the period of time from the start of input to the end of input is less than the threshold value, the shape is divided by a series of multiple strokes. In this case, since two strokes 411 and 412 satisfy the above-described conditions (i) to (iii), it is determined that these strokes 411 and 412 are input for dividing the shape. Accordingly, the two strokes 411 and 412 are not recognized separately from the shape, thus, avoiding to be recognized as a plus sign, for example.

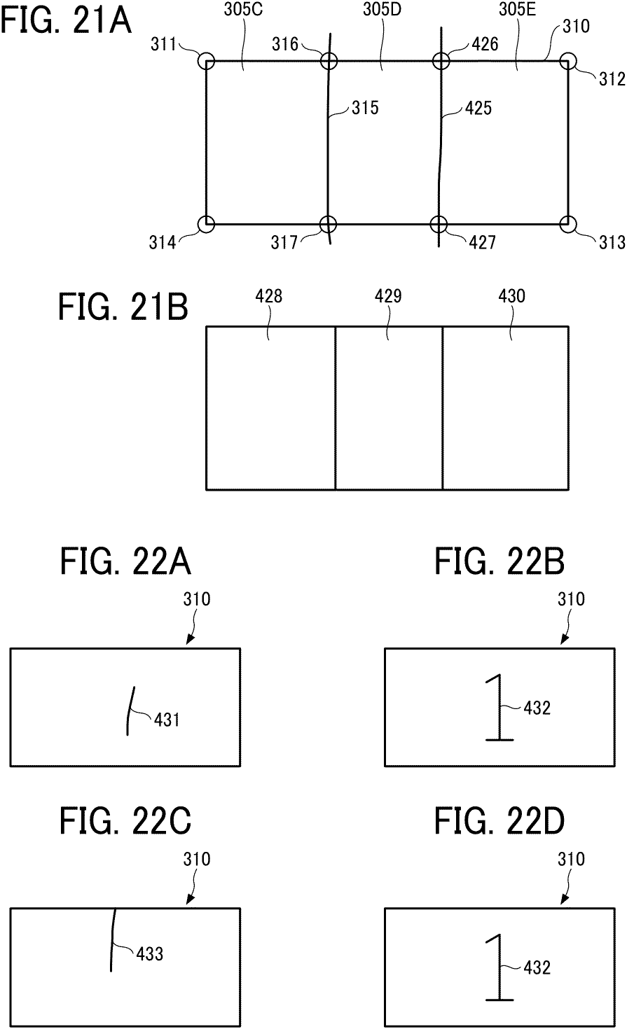

Further, as illustrated in FIGS. 21A and 21B, the strokes may not intersect each other, and the shape may be divided horizontally or vertically by a plurality of parallel strokes. FIGS. 21A and 21B illustrate an example of a shape to be divided into three shapes by a plurality of strokes that are parallel to each other. FIG. 21A illustrates a state in which a stroke 425 is added to the shape of FIG. 9. In this case, the shape dividing unit 29 creates a divided shape 305C, a divided shape 305D, and a divided shape 305E. The divided shape 305C is surrounded by a vertex 311, intersection points 316 and 317, and a vertex 314. The divided shape 305D is surrounded by intersection points 316, 426, 427, and 317. The divided shape 305E is surrounded by an intersection point 426, and vertices 312, 313, and an intersection point 427.

The coordinate conversion unit 30 converts the sides of the shape 310 among the divided shapes 305C to 305E. from straight lines to coordinate point sequences. With this conversion, as illustrated in FIG. 21B, the conversion unit 23 can recognize the coordinate point sequences as three formatted divided shapes 428, 429 and 430.

Although the number of strokes 411 and 412 for division is two in FIGS. 20A and 20B and three in FIGS. 21A and 21B, the number of strokes may be four or more.

### Character Recognition

The display apparatus 2 according to the present embodiment does not require the user to switch the mode from the handwritten character recognition mode to the shape mode. For this reason, there may be a case where a stroke is recognized as one or more characters.

FIGS. 22A to 22D are an illustration for explaining a case where a stroke is recognized as characters. In FIG. 22A, a stroke 431 perpendicular to the shape 310 is handwritten, but the stroke 431 does not intersect the shape 310 at all. In this case, since the stroke 431 does not satisfy the condition (ii) for dividing, the conversion unit 23 performs character recognition on the stroke 431. In FIG. 22B, the stroke 431 is recognized as a character 432 of “1”. In this case, if an attribute is set to the shape 310, the display apparatus 2 is able to display the character 432 with the attribute set to the shape 310.

In FIG. 22C, a stroke 433 substantially perpendicular to the shape 310 is handwritten, but only the upper end of the stroke 433 intersects the shape 310. In this case, since the stroke 433 does not satisfy the condition (ii) for dividing, the conversion unit 23 performs character recognition on the stroke 433. In FIG. 22D, the stroke 433 is recognized as the character 432 of “1”.

As described above, the display apparatus 2 according to the present embodiment enables a user to divide a shape by a stroke, or to input a character on a shape, without requiring the user to switch from the handwritten character recognition mode to the shape mode.

When the hand drafted data representing a character is input to such as a table (shape), as long as the character does not intersect the shape such that there is no intersection point, or the character does not intersect but is recognized as a ruled line (shape) in the table, the display apparatus 2 displays the character as hand drafted data, independent of the shape.

Further, the shape may be divided in a state where the character 432 is present in the shape. In this case, when the shape is divided, the character 432 belongs to one of the two divided shapes according to the position of the stroke data.

### Division of Shape Other Than Rectangle

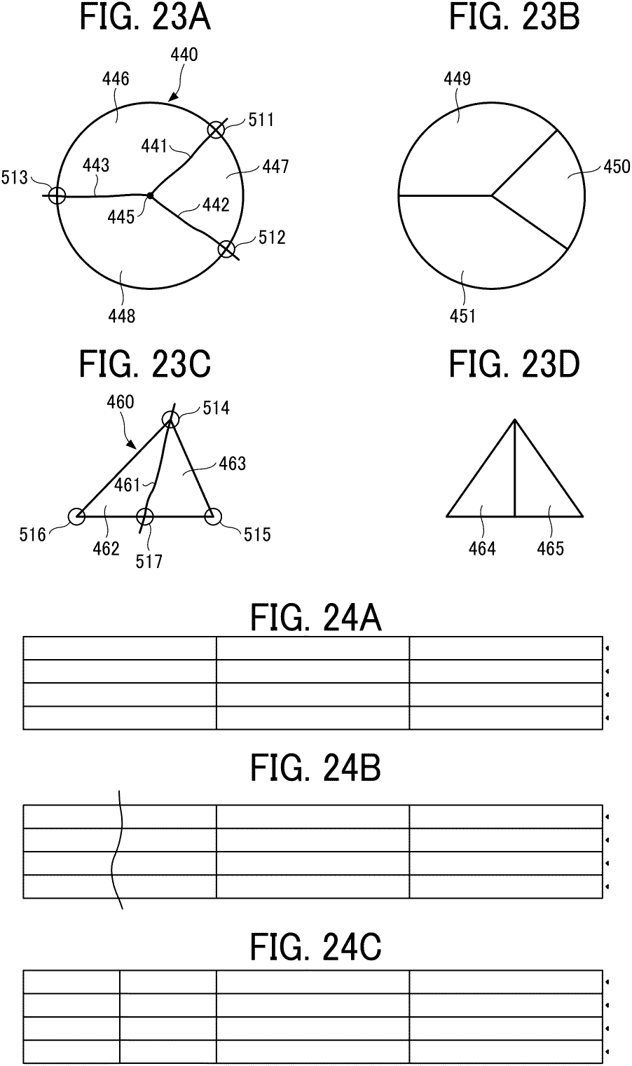

As illustrated in FIGS. 23A to 23D, the display apparatus 2 may also divide shapes other than rectangles. FIG. 23A illustrates an example of dividing a circle. In FIG. 23A, three strokes 441 to 443 passing through the center 445 of the circle 440 are handwritten on the circle 440. In this case, three fan-shaped divided shapes 446 to 448 are generated by the strokes 441 to 443, and intersection points 511 to 513 on the circular arc.

The shape dividing unit 29 traces black pixels clockwise from the center 445 of the circle. When the intersection point 511 is reached from the center 445, the shape dividing unit 29 traces black pixels clockwise to reach the intersection point 512, and returns to the center 445. The shape dividing unit 29 performs similar processing so as not to pass through the same circular arc.

As illustrated in FIG. 23B, the conversion unit 23 converts the divided shapes 446 to 448 into three formatted divided shapes 449 to 451. The formatted divided shapes 449 to 451 may be converted, based on their forms, into sector shapes.

In the case of a circle, among the conditions (I) to (iii), the condition (i) is the same as described above, but the conditions (ii) and (iii) differ as follows.

(ii) The point detection unit 28 determines whether the obtained straight line intersects with the center and the circumference of the circle.

(iii) When the straight line intersects with the center and circumference of the circle, the point detection unit 28 determines whether or not the intersection angle between the straight line and the tangent to the circle at the intersection point is, for example, 80 to 100 degrees.

FIG. 23C illustrates an example of dividing a triangular shape. In FIG. 23C, one stroke 461 is handwritten on a triangle 460. In this case, two triangular divided shapes 462 and 463 are generated by an intersection point 517 between the stroke 461 and the triangle 460 and a vertex 514.

The shape dividing unit 29 traces black pixels clockwise from the intersection point 517. The shape dividing unit 29 reaches a vertex 516 from the intersection point 517, and a vertex 514 from the vertex 516. The shape dividing unit 29 traces black pixels clockwise to reach the intersection point 517 at the branch. The shape dividing unit 29 does not pass through the same side of the triangle, but traces black pixels from the vertex 514 (or the intersection point 517) clockwise to pass through the vertex 515 and the intersection point 517, and returns to the vertex 514.

The conversion unit 23 converts the divided shapes 462 and 463 into new shapes, such that the divided shapes 462 and 463 are converted into two formatted divided shapes 464 and 465 as illustrated in FIG. 23D. The formatted divided shapes 464 and 465 may be converted, based on their forms, into triangles.

In the case of a triangle, among the conditions (i) to (iii), the condition (i) is the same as described above, but the condition (ii) differs as follows. Further, the condition (iii) is not necessary.

(ii) The point detection unit 28 determines whether the straight line obtained from the stroke intersects with an arbitrary vertex and an arbitrary side of the triangle. The intersection between the straight line and the vertex of the triangle may be determined based on whether or not the straight line passes the vertex, or at a point within a certain distance from the vertex.

When the shape dividing unit 29 arbitrarily divides the original triangle 460 into two shapes other than two triangles, it may be determined whether the stroke intersects two different sides of the triangle, instead of determining the intersection between the straight line and the vertex of the triangle.

The shapes of FIGS. 23A to 23D are examples. Since the display apparatus 2 according to the present embodiment converts the shape into the coordinate point sequence, the shape can be converted to have various forms according to the shape formed by the stroke and the original shape. For example, when a stroke passes through a diagonal vertex of a rectangle, the display apparatus 2 can divide the rectangle into two triangles. It is also possible to divide a pentagon into three triangles, etc.

### Application to Tables

Although division of a shape by a stroke has been described as an example in this embodiment, the shape may be a cell included in a table. In this disclosure, the table refers to a style of presentation in which pieces of information are arranged so as to be easily viewed. The table includes one dimensional table and two dimensional table, and either table may be used in this embodiment. Also, there may be only one cell in the table. In such case, the table is processed in a similar manner as the shape.

FIGS. 24A to 24C illustrate examples of a table. FIG. 24A is a table of four rows and three columns. For example, when the user wants to increase the number of columns, the user handwrites a vertical stroke on an arbitrary column. In FIG. 24B, a vertical stroke is handwritten on the first column. Since the stroke satisfies the conditions (i) to (iii) for each cell in the first column, each cell is divided into two divided shapes. Therefore, the conversion unit 23 recognizes the two divided shapes as new formatted divided shapes for each cell, so that one column can be divided into two columns as illustrated in FIG. 24C.

Although all the cells in one column are divided in FIGS. 24, the display apparatus 2 may divide only a part of the cells in one column according to the cells crossed by the stroke. The display apparatus 2 divides columns in FIGS. 24. Similarly, the display apparatus 2 may divide rows.

As described above, the display apparatus 2 according to the present embodiment enables a user to divide a shape by a stroke, without requiring the user to switch from the handwritten character recognition mode to the shape mode. Since it is not necessary to switch the mode, the display device 2 can perform character recognition without requiring the user to switch from the shape mode to the handwritten character recognition mode. For example, when the user inputs, by hand drafted data, a character inside a shape, the display apparatus 2 can convert the character into text. Further, since the display apparatus 2 recognizes the divided shape as a new shape, the previously-provided shape may be divided by one or more strokes to generate various types of shape. For example, there is no restriction that the shape can only be divided into upper, lower, left and right regions equally, or the shape can only be divided into two regions at a time.

### Second Embodiment

In the first embodiment, processing to divide a shape by a stroke has been described. In the second embodiment, connection of shapes will be described. In the following, assuming that the user draws a flowchart by hand, a stroke that is hand drafted to connect shapes can be converted into a straight line for connecting the shapes. In the related art, a stroke can be converted into a straight line that simply connects shapes. However, it was not possible to move the straight line, even when the user moves the shapes being connected by the straight line.

In the present embodiment, the hardware configuration illustrated in FIG. 3 and the functional configuration illustrated in FIG. 4 described in the above embodiment are applicable. However, in this embodiment, the shape dividing unit 29 and the coordinate conversion unit 30 are not used, such that they may not be provided. Further, the point detection unit 28 is likely to detect a contact point where a stroke and a shape is made in contact. However, depending on how the stroke is written, an intersection point where a stroke and a shape intersects each other may be detected. For this reason, the intersection includes the case where at least a common point is detected between the stroke and the shape.

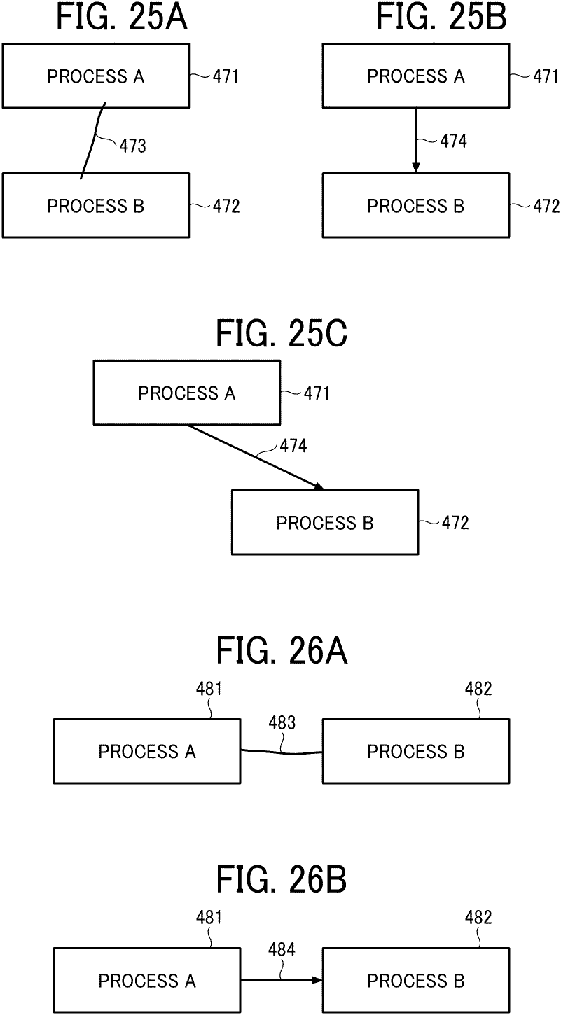

FIGS. 25A to 25C are an illustration for explaining connection between shapes, according to the embodiment. In FIG. 25A, two converted rectangles 471 and 472 are displayed. The long sides of the rectangles 471 and 472 are parallel to each other. The user handwrites a stroke 473 connecting the two rectangles 471 and 472. The point detection unit 28 detects intersection points between the two rectangles 471 and 472 and the stroke 473. When the intersection points are detected, the conversion unit 23 determines whether or not the stroke 473 is a stroke for connecting the two rectangles 471 and 472.

(i) The point detection unit 28 determines whether or not the stroke intersects the sides of the two shapes perpendicularly. That is, the point detection unit 28 determines whether or not the stroke intersects two shapes at two intersection points. In FIG. 25A, the point detection unit 28 determines whether or not the stroke 473 intersects the bottom side of the rectangle 471 and the top side of the rectangle 472 vertically. Alternatively, the two shapes may be connected horizontally.

(ii) The point detection unit 28 determines whether the sides of the two shapes for which the intersection point has been detected overlap in the vertical direction or the horizontal direction by a predetermined ratio or more. In FIG. 25A, it is determined whether or not the bottom side of the rectangle 471 and the top side of the rectangle 472, each for which the intersection point has been detected, overlap each other by a predetermined ratio or more in the horizontal direction. That is, whether the two shapes are aligned vertically or horizontally is determined.

When the above-described conditions (i) and (ii) are satisfied, the point detection unit 28 determines that the stroke 473 is a stroke for connecting the two rectangles 471 and 472. In this case, the conversion unit 23 recognizes the stroke 473 as a vertical straight line by the known recognition method in which the stroke is compared with the shape list. The conversion unit 23 further connects the two shapes by a straight line 474 (FIG. 25B). In this disclosure, the connection means that the straight line 474 follows with the two rectangles 471 and 472, even when the user moves one of the two rectangles 471 and 472.

Further, the conversion unit 23 sets an arrow head on the straight line 474 based on the direction from which the stroke 473 is written. In FIG. 25B, since the stroke is handwritten from top to bottom, the arrow head is directed to the rectangle 472.

As illustrated in FIG. 25C, even when the rectangle 472 moves, the straight line 474 remains in contact with the rectangle 472. In this way, even if the user moves the rectangle 472, it is not necessary to connect the rectangle 471 and 472 with a stroke again.

Further, in order to connect a rhombus and a rhombus or a rhombus and a rectangle, the point detection unit 28 determines the following two conditions. The rhombus represents a branch in some cases, for example, in the flowchart.

(iii) The point detection unit 28 determines whether at least one of two shapes is a rhombus and a stroke passes through the apex of the rhombus.

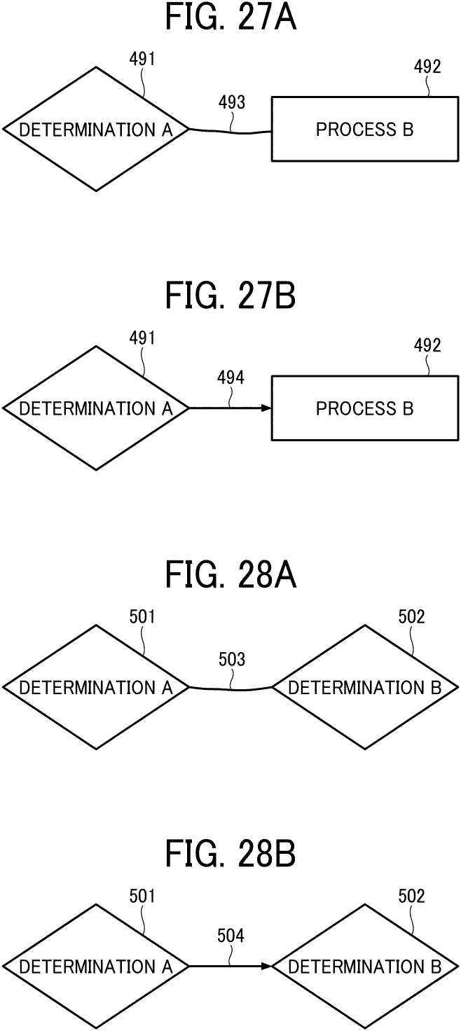

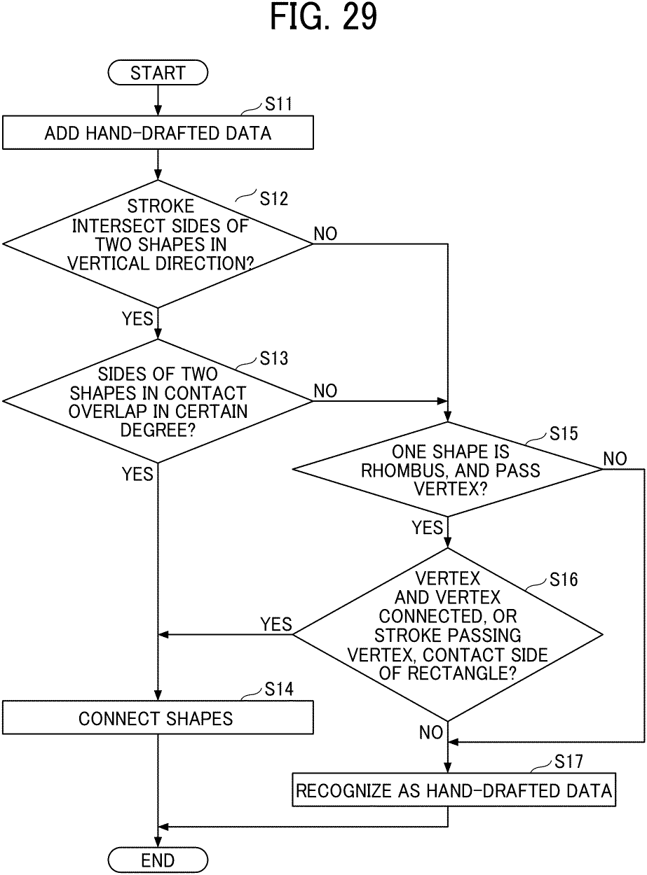

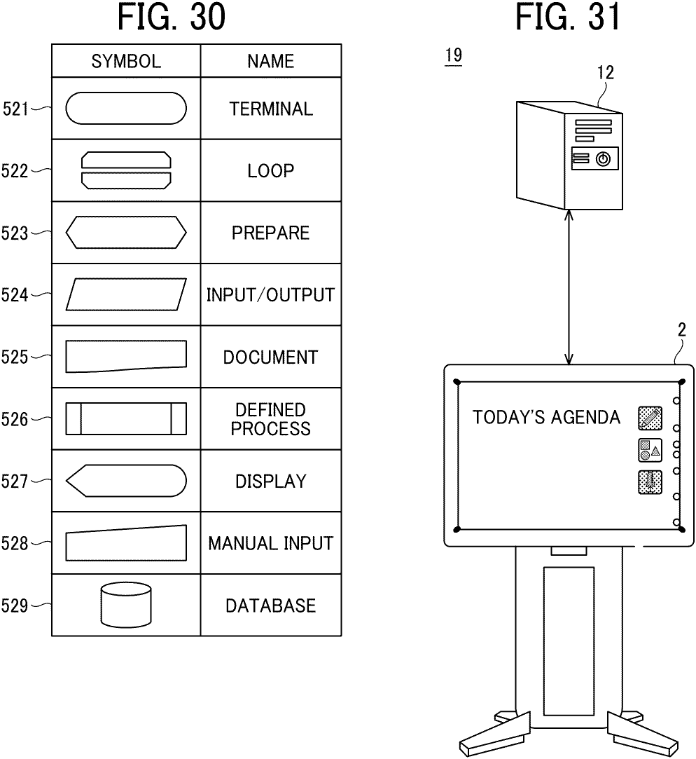

(iv) The point detection unit 28 determines whether a stroke passes through the vertices of the rhombus, or whether the stroke passing through the vertices of the rhombus intersects the sides of a rectangle in the vertical direction. The determinations of the conditions (iii) and (iv) will be described with reference to FIGS. 27A and 27B and 28A and 28B. Further, the stroke passing through the vertex or side includes a case where the stroke just contacts at the vertex or side.

### Examples of Connecting Shapes

Referring to FIGS. 26 to 28, example processing to connect two shapes by a stroke is described. FIGS. 26A and 26B illustrate an example of connecting two rectangles 481 and 482 displayed side by side. Since a stroke 483 in FIG. 26A satisfies the above-described conditions (i) and (ii) with respect to the two rectangles 481 and 482, the two rectangles 481 and 482 are connected by a straight line 484 as illustrated in FIG. 26B.

FIGS. 27A and 27B illustrate an example of connecting a rhombus 491 and a rectangle 492 displayed side by side. A stroke 493 in FIG. 27A connects a vertex of the rhombus 491 and a side of the rectangle 492. Since the stroke 493 in FIG. 27A satisfies the above-described conditions (iii) and (iv) with respect to the rhombus 491 and the rectangle 492, the rhombus 491 and the rectangle 492 are connected by a straight line 494 as illustrated in FIG. 27B.

FIGS. 28A and 28B illustrate an example of connecting two rhombuses 501 and 502 displayed side by side. A stroke 503 in FIG. 28A connects a vertex of one rhombus 501 and a vertex of the other rhombus 502. Since the stroke 503 in FIG. 28A satisfies the above-described conditions (iii) and (iv) with respect to the rhombuses 501 and 502, the rhombus 501 and the rhombus 502 are connected by a straight line 504 as illustrated in FIG. 28B.

### Processing or Operation for Connecting Shapes

FIG. 29 is a flowchart illustrating processing to connect shapes, performed by the display apparatus 2, according to the embodiment. In the description of FIG. 29, it is assumed that two shapes to be connected have already been converted from hand drafted data.

A user draws, by hand drafted data, a stroke connecting two shapes. The input receiving unit 21 receives input of stroke data (coordinate point sequence) by detecting coordinates of a position at which an input device such as the pen 2500 contacts the touch sensor 216. The drawing data generation unit 22 acquires coordinates of each position touched by the pen tip of the pen 2500 from the input reception unit 21. The drawing data generation unit 22 connects a plurality of contact coordinates into a coordinate point sequence by interpolation, to generate stroke data (S11).

The point detection unit 28 determines whether or not the stroke intersects the two shapes perpendicularly (S12). That is, it is determined whether or not the stroke intersects the two shapes perpendicularly at two intersection points.

When a result of the determination at S12 is YES, the point detection unit 28 determines whether or not the sides of the two shapes for which the intersection point has been detected overlap by a predetermined ratio or more (S13). The direction in which it is determined whether or not the stroke overlaps is a direction perpendicular to the side with which the stroke intersects.

When a result of the determination at S13 is YES, the conversion unit 23 converts the stroke into a straight line and connects the two shapes with the straight line (S14). This straight line is perpendicular to the sides intersected by the stroke. Further, it is preferable that the straight line passes through a midpoint of each side at which the stroke intersects.

When a result of the determination at S12 or S13 is NO, the point detection unit 28 determines whether at least one of the shapes is a rhombus, and the stroke passes through a vertex of the rhombus (S15). Based on determination of this step, the display apparatus 2 can connect the rhombus, which may be used in the flowchart, for example.

When a result of the determination at S15 is YES, in one example, the point detection unit 28 determines whether or not the stroke passing through the vertex of the rhombus intersects the side of the rectangle perpendicularly. In another example, the point detection unit 28 determines whether the stroke is to connect the vertex of the rhombus and the vertex of the rhombus perpendicularly (S16).

When a result of the determination at S16 is YES, the conversion unit 23 converts the stroke into a straight line and connects the two shapes with the straight line (S14).

When a result of the determination at S15 or S16 is NO, the conversion unit 23 recognizes the stroke as hand drafted data (S17). In this case, the stroke may be recognized as a straight line or a character.

In the present embodiment, example processing to connect rectangles, a rhombus and a rectangle, and rhombuses, are described, but other shapes, such as other shapes to be used in the flowchart, may be connected in a substantially similar manner.

FIG. 30 illustrates a list of example shapes used in the flowchart. As illustrated in FIG. 30, the examples of shape include a terminal shape 521 representing start and end of processing, a loop shape 522 representing repetition of processing therebetween, a preparation shape 523 representing preprocessing, an input/output shape 524 representing input and output of data, a document shape 525 representing a document from which data is read, a defined process shape 526 representing defined processing, a display shape 527 representing display on a display or the like, a manual input shape 528 representing manual input by a user, and a database shape 529 representing a database.

The display apparatus 2 connects any desired combination of these shapes. When there is no straight line as in the case of the database having a curved upper line, the condition for connection may determine whether or not a center in the width direction and the stroke data contact with each other.

According to the one or more embodiments, shapes can be easily connected to each other by stroke, which is hand drafted.

In a first aspect, a display apparatus for displaying at least two shapes includes an input receiving unit, a conversion unit, and a display control unit. The input receiving unit receives stroke data input to a touch panel by an input device. The conversion unit converts the stroke data into a straight line and connects the two shapes with the straight line, in a case where the stroke data being input intersects at least one side of each of the two shapes. The display control unit displays, on a display, the straight line connecting the two shapes.

In a second aspect, connection means that, even in a case where one of the two shapes connected by the stroke data is moved, the connection between the moved shape and the stroke data is maintained.

In a third aspect, the conversion unit determines from which direction hand drafting of the stroke data starts, based on a start point of the stroke data at which the input device is made in contact with the touch panel, and an end point of the stroke data at which the input device is separate from the touch panel. The display control unit adds an arrow head indicating the determined direction, to the straight line, for display.

In a fourth aspect, a point detection unit determines that the two shapes are to be connected by the stroke data, in a case where the stroke data and the sides of the two shapes intersect perpendicularly, and the sides of the two shapes each having the intersection point being detected overlap by a predetermined ratio or more in the vertical direction or the horizontal direction.

In a fifth aspect, it is assumed that at least one of the two shapes is a rhombus, and the stroke data intersects with a vertex of the rhombus. In such case, in case the other shape is a rhombus, the stroke data passes a vertex of one rhombus and a vertex of the other rhombus. In case the other shape is a rectangle, the stroke data intersects with the vertex of the rhombus, and further with a side of a rectangle in a vertical direction. In the above-described case, the point detection unit determines that the rhombus and the rhombus, or the rhombus and the rectangle, are to be connected by the stroke data.

In a sixth aspect, the display control unit connects, with the straight line, midpoints of sides of the two shapes each intersecting with the stroke data.

In a seventh aspect, the two shapes are each a shape used in a flowchart.

In an eighth aspect, a display method is performed by a display apparatus. The method includes: displaying a shape; receiving stroke data input to a touch panel with an input device: in a case where stroke data that divides the shape is input, converting a plurality of divided shapes, generated from the stroke data and the shape, into a plurality of converted shapes; and displaying the plurality of converted shapes.

### Third Embodiment

The display apparatus 2 can perform processing in a stand-alone type, but can also be applied to a server-client system.

### Application to Client-Server System

FIG. 31 is a schematic diagram illustrating an example of a configuration of the display system 19 according to the present embodiment. The function of the display apparatus 2 can also be implemented in a client- server system as illustrated in FIG. 31. The display apparatus 2 and a server 12 are connected to each other through a network such as the Internet.

In the display system 19, the display apparatus 2 includes the input receiving unit 21, the drawing data generation unit 22, the display control unit 24, the network communication unit 26, and the operation receiving unit 27 illustrated in FIG. 4.

The server 12 includes a conversion unit 23, a data recording unit 25, a point detection unit 28, a shape dividing unit 29, a coordinate conversion unit 30, and a network communication unit 26.

The network communication unit 26 of the display apparatus 2 transmits the stroke data to the server 12. The server 12 performs substantially the same processing as in the flowcharts of FIGS. 15 and 29 and transmits the recognition result to the display apparatus 2.

As described above, in the display system 19, the display apparatus 2 and the server 2 interactively process and display text data. Further, since the object data is stored in the server 12, the display apparatus 2 or a PC disposed at a remote site can connect to the server 12 and share the object data in real time.

As described above, the display apparatus 2 in the server-client system according to the present embodiment has advantageous advantages, which are substantially similar to the advantages of the first and second embodiments.

The above-described embodiments are illustrative and do not limit the present disclosure. Thus, numerous additional modifications and variations are possible in light of the above teachings within the scope of the present disclosure. Any one of the above-described operations may be performed in various other ways, for example, in an order different from the one described above.

In the description above, an electronic whiteboard is described as an example of the display apparatus 2, but this is not limiting. A device having a substantially the same functions as the electronic whiteboard may be referred to as an electronic information board, an interactive board, or the like. The present disclosure is applicable to any information processing apparatus having a touch panel. Examples of the information processing apparatus with a touch panel include, but not limited to, a projector (PJ), a data output device such as a digital signage, a head up display (HUD), an industrial machine, an imaging device such as a digital camera, a sound collecting device, a medical device, a network home appliance, a notebook personal computer (PC), a mobile phone, a smartphone, a tablet terminal, a game machine, a personal digital assistant (PDA), a wearable PC, and a desktop PC.

The display apparatus 2 may detect the coordinates of the tip of the pen using ultrasonic waves, although the coordinates of the tip of the pen are detected using the touch panel in the above-described embodiment. The pen emits an ultrasonic wave in addition to the light, and the display apparatus 2 calculates a distance based on an arrival time of the sound wave. The display apparatus 2 determines the position of the pen based on the direction and the distance, and a projector draws (projects) the trajectory of the pen based on stroke data.

In the block diagram such as FIG. 4, functional units are divided into blocks in accordance with main functions of the display apparatus 2, in order to facilitate understanding the operation by the display apparatus 2. No limitation to a scope of the present disclosure is intended by how the processes are divided or by the name of the processes. The processes implemented by the display apparatus 2 may be divided to a larger number of processes depending on the contents of processes. Alternatively, one unit of processing may be a group of divided processing.

For example, a display system including any one of the above-described display apparatus and a server may be provided.

Each of the functions of the described embodiments may be implemented by one or more processing circuits or circuitry. In this specification, the “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules designed to perform the recited functions.

Embodiments of the present disclosure can provide significant improvements in computer capability and functionality. These improvements allow users to take advantage of computers that provide more efficient and robust interaction with tables that is a way to store and present information on information processing apparatuses.

In addition, embodiments of the present disclosure can provide a better user experience through the use of a more efficient, powerful, and robust user interface. Such a user interface provides a better interaction between humans and machines.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A display apparatus comprising circuitry configured to:
display, on a display, shape data;
receive stroke data input to a user interface with an input device;
determine whether the stroke data intersects with the shape data;
based on a determination that the intersection is detected, convert the stroke data and the shape data, being collectively recognized, into converted shape data; and
display, on the display, the converted shape data in place of the shape data.

2. The display apparatus of claim 1, wherein
the circuitry is configured to
convert the shape data into a coordinate point sequence, and
convert the coordinate point sequence representing the shape data, and the stroke data, to generate the converted shape data.

3. The display apparatus of claim 1, wherein
the circuitry is configured to
determine whether the stroke data indicates division of a shape represented by the shape data, and
based on a determination that the stroke data indicates division of the shape, convert a plurality of divided shapes, generated from the shape data and the stroke data, into a plurality of converted shapes representing the converted shape data.

4. The display apparatus of claim 3, wherein
the circuitry is configured to
determine that the stroke data indicates division of the shape, based on detection of at least two intersection points at which the stroke data intersects at least one side of the shape represented by the shape data, and
generate the plurality of divided shapes, each being formed by the stroke data and a part of the shape divided by the stroke data.

5. The display apparatus of claim 4, wherein
the shape is a rectangle,
the at least two intersection points are the points at which the stroke data intersects opposing sides of the rectangle perpendicularly, and
the circuitry is configured to convert the plurality of divided shapes, each defined by the at least two intersection points, into the plurality of converted shapes, such that the rectangle is divided horizontally or vertically.

6. The display apparatus of claim 5, wherein
each of the at least two intersection points is off a center of the side, and
at least two of the plurality of converted shapes have sizes different from each other.

7. The display apparatus of claim 4, wherein
the shape is a triangle,
the at least two intersection points include a point at which the stroke data intersects one side of the triangle, and a point at which the stroke data intersects a vertex of the triangle, and
the circuitry is configured to convert the plurality of divided shapes, each defined by the at least two intersection points, into the plurality of converted shapes, such that the triangle is divided into a plurality of triangles.

8. The display apparatus of claim 4,
wherein the shape is a circle,
the at least two intersection points are the points at which the stroke data intersects a circumference of the circle, the stroke data passing through a center of the circle, and
the circuitry is configured to convert the plurality of divided shapes, each defined by the at least two intersection points, into the plurality of converted shapes, such that the circle is divided into a plurality of fan-shaped shapes.

9. The display apparatus of claim 4, wherein
the stroke data includes at least two stroke data that intersect each other,
the circuitry is configured to:
detect an intersection point of the at least two stroke data, in addition to the at least two intersection points at which each stroke data intersects the shape;
generate at least four divided shapes, using at least one vertex of the shape, the intersection point of the at least two stroke data, and the at least two intersection points of the stroke data and the shape; and
convert the at least four divided shapes into at least four converted shapes.

10. The display apparatus of claim 4, wherein
in a case that the at least two intersection points between the stroke data and the shape is not detected,
the circuitry is configured to convert the stroke data into a character.

11. The display apparatus of claim 3, wherein
the plurality of divided shapes inherits attributes set in the shape data.

12. The display apparatus of claim 1, wherein
the shape data is a cell in a table.

13. The display apparatus of claim 1, wherein
based on a determination that the stroke data intersects two shapes represented by the shape data at two intersection points,
the circuitry is configured to convert the stroke data into a straight line, and
display the straight line connecting the two shapes, as the converted shape data.

14. The display apparatus of claim 13, wherein
the connection between the straight line, represented by the stroke data, and the two shapes maintains, even after a display position of one of the two shapes changes.

15. The display apparatus of claim 13, wherein
the circuitry is configured to determine from which direction hand drafting of the stroke data starts, based on a start point of the stroke data at which the input device is made in contact with the user interface, and an end point of the stroke data at which the input device is apart from the user interface, and
display the straight line added with an arrow head indicating the direction of hand drafting.

16. The display apparatus of claim 13, wherein
in a case where the stroke data and sides of the two shapes intersect perpendicularly, and the sides having the intersection points being detected overlap by a predetermined ratio or more in a vertical direction or a horizontal direction,
the circuitry is configured to determine that the stroke data is to connect the two shapes.

17. The display apparatus of claim 13, wherein
based on a determination that the stroke data intersects vertices of the two shapes, each shape being a rhombus,
the circuitry determines to connect the rhombus and the rhombus with the straight line.

18. The display apparatus of claim 13, wherein
based on a determination that the stroke data intersects a vertex of one of the two shapes being a rhombus, and a side of the other one of the two shapes being a rectangle,
the circuitry determines to connect the rhombus and the rectangle with the straight line.

19. The display apparatus of claim 13, wherein
the circuitry connects sides of the two shapes with which the stroke data intersects, each at the center thereof, with the straight line.

20. The display apparatus of claim 13, wherein the two shapes are a part of a flowchart.

21. A display method, comprising:
displaying, on a display, shape data;
receiving stroke data input to a touch panel with an input device:
determining whether the stroke data intersects with the shape data;
converting the stroke data and the shape data, being collectively recognized, into converted shape data, based on a determination that the intersection is detected; and
displaying, on the display, the converted shape data in place of the shape data.

22. A non-transitory recording medium storing a plurality of instructions which, when executed by one or more processors, cause the processors to perform a display method comprising:
displaying, on a display, shape data;
receiving stroke data input to a touch panel with an input device;
determining whether the stroke data intersects with the shape data;
converting the stroke data and the shape data, being collectively recognized, into converted shape data, based on a determination that the intersection is detected; and
displaying, on the display, the converted shape data in place of the shape data.
